(19) United States
(12) Patent Application Publication
(10) Pub. No.: US 2008/0138545 A1
(43) Pub. Date: Jun. 12, 2008

(54) IMAGE-RECEIVING MATERIAL FOR ELECTROPHOTOGRAPHY

(75) Inventors: Tomomi TATEISHI, Minami-Ashigara-Shi (JP); Fujio Kakimi, Minami-Ashigara-Shi (JP); Masataka Murata, Minami-Ashigara-Shi (JP)

Correspondence Address: SUGHRUE MION, ZINN, MACPEAK & SEAS, 2100 Pennsylvania Avenue, N. W., Washington, DC, 20037, US

(73) Assignee: FUJIFILM Corporation

(21) Appl. No.: 12/027,476

(22) Filed: Feb. 7, 2008

Related U.S. Application Data
(63) Continuation of application No. 09/951,407, filed on Sep. 14, 2001.

(30) Foreign Application Priority Data
Sep. 14, 2000 (JP) 2000-279265
Feb. 16, 2001 (JP) 2001-39560
Mar. 2, 2001 (JP) 2001-57702

(51) Int. Cl. B41M 5/40

(52) U.S. Cl. 428/32.39

(57) ABSTRACT

The present invention is to provide an image-receiving material, such as an image-receiving sheet, for electrophotography, which is excellent in smoothness (gloss), touch and sheet passing property and usable for the photography and which is free from adhesion or blocking to each other during the storage. The present electrophotographic image-receiving material comprises a support, and a toner image-receiving layer containing a thermoplastic resin formed on the support. Organic particles having a glass transition temperature or melting point not higher than a fixing temperature at which an image is fixed on said toner image-receiving layer are incorporated into the toner image-receiving layer or a second layer forming the electrophotographic image-receiving sheet other than the toner image-receiving layer on the toner image-receiving layer side of said support. In addition, the center line average height on the surface of the support is 0.01 to 5 μm and a releasing agent selected from the group consisting of silicon compounds, fluorine compounds and waxes is incorporated into the toner image-receiving layer or any additional layer.

### CROSS REFERENCE TO RELATED APPLICATIONS

This is a continuation of application Ser. No. 09/951,407 filed Sep. 14, 2001, which claims priority under 35 USC 119 from Japanese Patent Application Nos. 2000-279265, 2001-039560, and 2001-057702, the disclosures of which are incorporated by reference herein.

### BACKGROUND OF THE INVENTION

The present invention relates to an image-receiving material or sheet for electrophotography.

An electrophotographic method is employed for output devices of copying machines and personal computers because in this method, dry treatment is employed, the printing speed is high and general papers (plain papers and wood free papers) are usable.

However, when an image information such as a face or scenery is to be output as a photograph, a specified photographic paper is necessitated because the general papers are poor particularly in the gloss. For improving the gloss, image-receiving sheets for electrophotography, which comprise a support and a toner image-receiving layer containing a thermoplastic resin formed on the support were proposed in J. P. KOKAI Nos. Hei 4-212,168 and 8-211,645.

However, electrophotographic glossy image-receiving sheets are designed so that a toner image-receiving layer thereof is improved in the heat response (a phenomenon of sharp melt or softening of the image-receiving layer by the fixing heat) at a low temperature and the fixation. Therefore, these sheets have a problem of so-called blocking. As a result, the following problems are caused: When the electrophotographic image-receiving sheets are stored in piles or in the form of a roll before use, the support of an electrophotographic image-receiving sheet is adhered to the toner image-receiving layer of another electrophotographic image-receiving sheet placed below the support. In another case, the support of an electrophotographic image-receiving sheet is adhered to the toner image-receiving layer of another electrophotographic image-receiving sheet placed below the support and, therefore, when the former sheet is taken out from the pile of the sheets, the toner-receiving layer is peeled out of the support of the latter sheet.

It is effective for solving the blocking problem that fine organic and/or inorganic particles are incorporated into at least one of layers constituting the electrophotographic image-receiving sheet on the toner image-receiving layer side of the support or into the toner image-receiving layer. Although this method is effective for preventing the blocking, it also causes a problem that the gloss of an obtained image is reduced.

In addition, when an image information such as a face or scenery is to be output as a photograph, the general papers are poor, particularly in gloss or touch is different from that of actual photographs. For improving the gloss, image-receiving materials for electrophotography, which comprise a support and a toner image-receiving layer containing a thermoplastic resin formed on the support were proposed in J. P. KOKAI Nos. Hei 4-212,168 and 8-211,645. Further, image-receiving sheets for electrophotography, which comprises a base paper having a thermoplastic resin layer on both surfaces thereof, are proposed in J. P. KOKAI No. Hei 8-21164.

Recently, a wax, silicon compound or the like is incorporated into a toner to impart a releasability thereto from a heat roller in a fixing part. Accordingly, an oil-less machine which is free from a fixing oil and is easy to be maintained has begun to be spread.

However, the toner image-receiving layer containing such a thermoplastic resin easily offsets in the oil-less machine without the fixing oil and, as a result, there is easily caused a problem in transferring image-receiving sheets. To solve this problem, it is disclosed to incorporate an additive having a releasing effect into the thermoplastic resin layer in J. P. KOKAI Nos. Hei 11-52,604, 11-52,605, 11-52,606 and 11-212,292. This method has defects, however, that the glossy feeling is damaged or the photo-like touch is quite different from that of the actual photograph.

### BRIEF DESCRIPTION OF THE DRAWINGS

FIG. 1 is a schematic diagram showing a fixing belt system in a printer used in Examples, wherein 1 represents a fixing belt system, 2 a fixing belt, 3 a heating roller, 4 a pressure roller, 5 a tension roller, and 6 a cleaning roller.

### SUMMARY OF THE INVENTION

The first object of the present invention is to provide an image-receiving material, such as an image-receiving sheet, for electrophotography, which is excellent in smoothness (gloss) and usable for the photography and which is free from adhesion or blocking to each other during the storage.

The second object of the present invention is to provide an image-receiving material for electrophotography, which is excellent in sheet passing property, gloss and a photo-like touch and which is suitable for use for the photography.

After intensive investigations made for the purpose of solving the above-described problems, the inventors have found that the above-described first objective can be attained by providing an image-receiving material for electrophotography, which comprises a support and a toner image-receiving layer containing a thermoplastic resin formed on the support, wherein an organic particle having a glass transition temperature or melting point not higher than the fixing temperature is incorporated into the toner image-receiving layer or a layer forming the electrophotographic image-receiving material other than the toner image-receiving layer on the toner image-receiving layer side of the support. In addition, the inventors have found that the above-described second objective can be attained by providing an image-receiving material for electrophotography, which comprises a support and a toner image-receiving layer containing a thermoplastic resin formed on the support and optional additive layers, wherein the center line average height on the surface of the support is 0.01 to 5 μm, and the toner image-receiving layer or any other additional layer contains a mold releasing agent selected from the group consisting of silicon compounds, fluorine compounds and waxes.

The present invention has been completed on the basis of these findings.

### DESCRIPTION OF THE PREFERRED EMBODIMENTS

### Support

The support usable for forming the photographic image-receiving sheets of the present invention is not particularly limited so far as it is resistant to the fixing temperature and it satisfies the requirements such as smoothness, whiteness, slipping, abrasion, antistatic property and dent after the fixing.

The support usable herein is, for example, base papers (including synthetic papers), synthetic resin sheets and coated papers obtained by coating such sheets with a resin or the like.

The support may be either mono-layered or multi-layered.

The material for the base paper can be selected from among various materials used for forming well-known base papers without any particular limitation. Examples of them are natural pulps selected from those of conifers and broadleaf trees; synthetic pulps made of plastic materials such as polyethylene and polypropylene; and mixtures of the natural pulp and synthetic pulp.

If necessary, the base paper may contain fillers such as clay, talc, calcium carbonate and fine urea resin particles; sizing agents such as rosin, alkenylketene dimers, higher fatty acids, epoxidized fatty acid amides and alkenylsuccinic acids; strength additives such as starches, polyamide polyamine epichlorohydrin and polyacrylamide; and fixing agents such as alumina sulfate and cationic polymers.

The basis weight of the base paper is in the range of, for example, 50 to 250 g/m², preferably 100 to 180 g/m². The thickness of the base paper is in the range of, for example, 20 to 250 μm, preferably 50 to 180 m.

Preferred examples of the base papers include wood free papers and papers described in, for example “Shashin Kogaku no Kiso (Fundamentals of Photographic Engineering)-Gin'en Shashin-Hen (Edition of Silver salt Photos)-” (edited by Nippon Shashin Gakkai and published by Corona Co., Ltd. in 1979), pages 223 to 240.

The base paper used for forming the support is preferably that made of pulp fibers having, for example, such a fiber length distribution that the total of 24 mesh screen residue and 42 mesh screen residue is 20 to 45% by mass, and the 24 mesh screen residue is not larger than 5% by mass so as to impart the desired center line average height to the surface thereof as described in, for example, J. P. KOKAI No. Sho 58-68037. The center line average height can be controlled by the surface treatment by heat or pressure with a machine calender and a super calender.

A synthetic resin sheet (film) as the support is produced by molding a synthetic resin in the form of a sheet. It can be obtained by, for example, extrusion-molding a polyolefin resin such as polypropylene resin to form a sheet.

A coated paper used as the support is a paper or a sheet obtained by coating one or both surfaces of a sheet of a base paper or the like with a resin, a rubber latex or a high-molecular material. The amount of the coating varies depending on the use of the support. The coated papers include, for example, art paper, cast-coated paper and Yankee paper.

The sheet of the base paper or the like may be laminated with a resin, a rubber or a high-molecular sheet or film. The materials usable for the lamination include, for example, polyolefin, polyvinyl chloride, polyethylene terephthalate, polystyrene, polymethacrylates, polyethylene terephthalate, polycarbonates, polypropylene, polyimides and triacetylcellulose. Such a sheet or film may be treated to impart white reflection thereto. The treatment can be conducted by, for example, incorporating a pigment such as titanium oxide into the sheet or film.

The support may be a laminate of supports selected from among the above-described supports.

In a preferred example of methods of coating the base paper with the resin or the like, the base paper is coated or impregnated with a resin solution or suspension, or the solution or suspension is sprayed on the paper.

Both or one surface of the base paper is preferably activated by corona discharge treatment, flame treatment, glow discharge treatment or plasma treatment for the purpose of improving the adhesion with the resin or the like to be applied to the base paper.

When the coated paper is used as the support, a thermoplastic resin is preferred as the resin to be applied to the surface of the base paper or the like.

Examples of the thermoplastic resins are as follows:

(A) Polyolefin resins such as polyethylene resin and polypropylene resin; copolymer resins composed of an olefin such as ethylene or propylene and another vinyl monomer; and acrylic resin,
(B) Thermoplastic resins having an ester linkage:

Polyester resins obtained by the condensation of a dicarboxylic acid component such as terephthalic acid, isophthalic acid, maleic acid, fumaric acid, phthalic acid, adipic acid, sebacic acid, azelaic acid, abietic acid, succinic acid, trimellitic acid or pyromellitic acid (such a dicarboxylic acid component may be substituted with a sulfonic acid group, carboxyl group or the like) with an alcohol component such as ethylene glycol, diethylene glycol, propylene glycol, bisphenol A, diether derivative of bisphenol A (such as 2 mol ethylene oxide adduct or bisphenol A or 2 mol propylene oxide adduct of bisphenol A), bisphenol S, 2-ethylcyclohexyldimethanol, neopentyl glycol, cyclohexyldimethanol or glycerol (such an alcohol component may be substituted with a hydroxyl group or the like); polyacrylic acid ester resins or polymethacrylic acid ester resins such as polymethyl methacrylate, polybutyl methacrylate, polymethyl acrylate and polybutyl acrylate; polycarbonate resins; polyvinyl acetate resins; styrene acrylate resins; styrene/methacrylic acid ester copolymer resins and vinyltoluene acrylate resins. Concrete examples of them are those described in J. P. Kokai Nos. Sho 59-101,395, Sho 63-7,971, Sho 63-799,972, Sho 63-7,973 and Sho 60-294,862. Commercially available thermoplastic resins usable herein are, for example, Vylon 290, Vylon 200, Vylon 280, Vylon 300, Vylon 103, Vylon GK-140 and Vylon GK-130 (products of Toyobo Co., Ltd.); Tafton NE-382, Tafton U-5, ATR-2009 and ATR-2010 products of Xao Corporation); Erither UE 3500, UE 3210 and XA-8153 (products of Unitika Ltd.); and Polyester TP-220 and R-188 (products of The Nippon Synthetic Chemical Industry Co., Ltd.),

(C) Polyurethane resin, etc.,
(D) Polyamide resin, urea resin, etc.,
(E) Polysulfone resin, etc.,
(F) Polyvinyl chloride resin, polyvinylidene chloride resin, vinyl chloride/vinyl acetate copolymer resin, vinyl chloride/vinyl propionate copolymer resin, etc.
(G) Polyol resins such as polyvinyl butyral; and cellulose resins such as ethyl cellulose resin and cellulose acetate resin, and
(H) Polycaprolactone resin, styrene/maleic anhydride resin, polyacrylonitrile resin, polyether resins, epoxy resins and phenolic resins.

The thermoplastic resins may be used either alone or in the form of a mixture of them.

When the coated paper is used as the support, the thermoplastic resin to be applied is particularly preferably polyethylene such as high-density polyethylene or low-density polyethylene, another polyolefin such as a polypropylene, or a polyester. These resins may be used in the form of a mixture of them.

Generally, a low-density polyethylene is used as the polyolefin. However, for improving the thermal resistance of the support, it is preferred to use polypropylene, a blend of polypropylene and polyethylene, a high-density polyethylene, or a blend of the high-density polyethylene and a low-density polyethylene. From the viewpoints of costs and suitableness for the laminate, the blend of the high-density polyethylene and the low-density polyethylene is most preferred.

In the blend of the high-density polyethylene and the low-density polyethylene, they are used in a mass ratio of 1/9 to 9/1, preferably 2/8 to 8/2 and most preferably 3/7 to 7/3. When polyethylene is applied to both surfaces of the support, the polyolefin to be applied to the back surface is preferably the high-density polyethylene or a blend of the high-density polyethylene and the low-density polyethylene. The molecular weight of polyethylene is not particularly limited. Desirably, both of high-density polyethylene and low-density polyethylene have a melt index of 1.0 to 40 g/10 min and a high extrudability.

For coating the paper, one or more thermoplastic resin layers may be formed thereon.

The thickness of the thermoplastic resin layer is, for example, 5 to 100 μm, preferably 10 to 50 μm. The thermoplastic resin layer formed on the surface of the paper may be the same or different from the thermoplastic resin layer formed on the back surface thereof, in respect of the components, physical properties, thickness and composition.

The resins to be applied or laminated is not limited to the thermoplastic resins. Therefore, monomers, resins obtained by treating thermoplastic resins with heat or light or by reacting them with a hardening agent or a crosslinking agent, and thermosetting resins are also usable. At least one of the resin layers to be formed may be the layers obtained by irradiating a monomer composition or a resin composition containing a photopolymerization initiator with ultraviolet rays and curing it. The resin composition used in this case contains an electron beam-curable organic compound as the main ingredient. The organic compounds are not particularly limited. These compounds may be either monomers or oligomers. They may be used either alone or in the form of a mixture of them.

In the resin layer to be formed on the support, the varieties of the U.V. curable organic compounds which are curable by the irradiation of ultraviolet rays are not limited at all. The U.V. curable resin composition is prepared by adding a suitable amount of a photo-polymerization initiator to the above-described electron beam-curable resin. Although the photopolymerization initiator is unnecessary for the resin composition which is curable by the electron beam in the present invention as a matter of course, the initiator does not inhibit the curing by the irradiation with electron beam even when it is contained therein. However, some of the photopolymerization inhibitors have a strong smell and, therefore, the meaningless use of the inhibitors must be avoided.

The unsaturated organic compound-containing resin composition may contain a white pigment and, if necessary, other additives. The electron beam-curable unsaturated compounds can be selected from, for example, the following compounds:

(1) acrylate compounds of monohydric to hexahydric, aliphatic, alicyclic and araliphatic alcohols and polyalkylene glycols,
(2) acrylate compounds of adducts of monohydric to hexahydric, aliphatic, alicyclic and araliphatic alcohols with an alkylene oxide,
(3) polyacryloylalkylphosphoric acid esters,
(4) reaction products of a carboxylic acid, a polyol and acrylic acid,
(5) reaction products of an isocyanate, a polyol and acrylic acid,
(6) reaction products of an epoxy compound and acrylic acid, and
(7) reaction products of an epoxy compound, a polyol and acrylic acid.

Concrete description will be given on these compounds. The electron beam-curable unsaturated compounds include polyoxyethylene epichlorohydrin-modified bisphenol A diacrylate, dicyclohexyl acrylate, epichlorohydrin-modified polyethylene glycol diacrylate, 1,6-hexanediol diacrylate, hydroxypivalic acid ester neopentyl glycol diacrylate, nonylphenoxypolyethylene glycol acrylate, ethylene oxide-modified phenoxyphosphoric acid acrylate, ethylene oxide-modified phthalic acid acrylate, polybutadiene acrylate, caprolactam-modified tetrahydrofurfuryl acrylate, tris(acryloxyethyl) isocyanurate, trimethylolpropane triacrylate, pentaerythritol triacrylate, pentaerythritol tetraacrylate, pentaerythritol pentaacrylate, dipentaerythritol hexaacrylate, polyethylene glycol diacrylate, 1,4-butadienediol diacrylate, neopentyl glycol diacrylate and neopentyl glycol-modified trimethylolpropane diacrylate. These organic compounds are usable either alone or in combination of two or more of them.

The photopolymerization initiators used in the present invention can be selected from among those widely known in the art. They can be suitably selected from ethylanthraquinone, methylbenzoyl formate, 1-hydroxycyclohexyl phenyl ketone, acetophenones such as acetophenone, diethoxyacetophenone and trichloroacetophenone, o-benzoylmethyl benzoate, benzophenone, Michler's ketone, benzil, benzoin, benzoin alkyl ethers, benzyl dimethyl ketal, tetramethylthiuram monosulfide, xanthone, thioxanthones, benzophenones, and azo compounds. A mixture of two or more of these photopolymerization initiators is also usable.

The amount of the photopolymerization initiator to be used is usually preferably in the range of 0.1 to 10% by mass based on the ultraviolet curable resin. It is preferred for improving the curing velocity to use a well-known photopolymerization accelerator such as N-methyldiethanol amine or bisdiethylaminobenzophenone in combination with the above-described photopolymerization initiator. Although the amount of the photopolymerization accelerator is not particularly limited so far as the effect thereof is exhibited, it is usually preferably 0.5 to 2 parts by weight per part by weight of the photopolymerization initiator.

The type of electron beam accelerators used for the irradiation with electron beam is not particularly limited. Electron beam irradiation apparatuses of Van de Graaff scanning type, double scanning type, curtain beam type or the like are usable. Among them, those of curtain beam type are effectively used because they are relatively inexpensive and their generating capacity is high. The acceleration voltage in the irradiation with the electron beam is preferably 100 to 300 kV or the like, and the absorbed dose is preferably 0.1 to 6.0 Mrad, particularly 0.2 to 4.0 Mrad. When the absorbed dose is less than 0.1 Mrad, the curing of the resin by the irradiation with the electron beam will be occasionally insufficient. On the contrary, when the absorbed dose is excessive, wasteful energy consumption is caused and the deterioration of the paper base is caused.

Oxygen concentration in the atmosphere in the irradiation with electron beam is preferably not higher than, for example, 500 ppm. When it is higher than 500 ppm, oxygen acts as a polymerization reaction inhibitor to make the curing of the resin composition insufficient. Because the electron ray-curable resin coating liquid is not directly brought into contact with air, it is not always necessary to reduce oxygen concentration in the atmosphere at the time of the irradiation with the electron beam. An inert gas such as nitrogen gas may be introduced therein for the purpose of preventing ozone formation by the irradiation with the electron beam or for the purpose of cooling the window heated when the electron beam passes through it.

Types of ultraviolet irradiation devices are not particularly limited. For example, low pressure mercury lamps, medium pressure mercury lamps, high pressure mercury lamps and metal halide lamps are usable. These lamps are suitably combined with a light reflector of condensing type, semi-condensing type or diffusion type. Because ultraviolet ray irradiation lamps generally generate a heat, a cooling device such as a water-cooled jacket, a cold mirror or an aluminum mirror is preferably used for cooling them. For attaining the sufficient curing, it is usually preferred to use two or more ultraviolet ray irradiation devices of at least 80 W/cm arranged in a row depending on the treatment velocity.

After curing the resin coating layer on the surface by the irradiation with ultraviolet rays and electron beam, the surface may be treated by corona discharge or a subbing layer may be formed on the surface for the purpose of improving the adhesion thereof to a toner image-receiving layer.

The surface of the thermoplastic resin layer of the coated paper may be subjected to a marking treatment, if necessary, to have a glossy surface, or fine surface, matte surface, or silk-finish surface as described in J. P. KOKAI No. Sho 55-26507. The surface of the thermoplastic resin layer on the side (back side) opposite to the electro-conductive layer which is formed if necessary may be matte. After the marking treatment, the surface can be further subjected to an activation treatment such as corona discharge treatment or flame treatment. After the activation treatment, an under coating treatment as described in J. P. KOKAI No. Sho 61-846,443 can be conducted.

Suitably selected various additives can be contained in the thermoplastic resin layer or the like so far as the object of the present invention is not impaired.

The thickness of the support to be used in the present invention is, for example, 25 to 300 μm, preferably 50 to 260 μm and more preferably 75 to 220 μm. The rigidity of the support is variable depending on the purpose thereof. The rigidity of the support for an electrophotographic image-receiving material having a photographic image quality is preferably close to that of a support for color photographic silver salt sheet.

From the viewpoint of the fixing property, the thermal conductivity of the support used in the present invention at a relative humidity of 65% at 20° C. is, for example, preferably at least 0.50 kcal/m·h·° C. The thermal conductivity can be determined according to a method described in J. P. KOKAI No. Sho 53-66279 by using a transfer paper having a humidity controlled according to JIS P 8111. The density of the support is preferably at least 0.7 g/cm³ from the viewpoint described above.

Various additives suitably selected so as not to adversely affecting the object of the present invention can be incorporated into the support. The additives include brightening agents, electric conducting agents, fillers and pigments and dyes such as titanium oxide, ultramarine and carbon black.

One or both surfaces of the support can be surface-treated or under-coated in various ways, for the purpose of improving the adhesion thereof to a layer to be formed thereon. The surface treatments include the treatment for forming a glossy surface, or fine surface, matte surface or silk-finish surface as described in J. P. KOKAI No. Sho 55-26,507, and activation treatment such as corona discharge treatment, flame treatment, glow-discharge treatment or plasma treatment. The under coating can be conducted by, for example, a method described in J. P. KOKAI No. Sho 61-846,443. The treatment may be conducted either singly or a combination of treatments such as the marking treatment followed by the activation treatment or a surface treatment such as the activation treatment followed by the under coating can be employed.

A hydrophilic binder, a semiconductive metal oxide such as alumina sol or a tin oxide, carbon black and another antistatic agent may be incorporated into the support used in the present invention and/or they may be applied to the surface or the back surface of the support. Concretely, supports described in J. P. KOKAI No. Sho 63-220,246 are usable.

Preferably, the support used in the present invention is resistant to the fixing temperature and capable of satisfying the requirements such as degree of whiteness, slipping, abrasion, antistatic property and dent after the fixing.

### Electrophotographic Image-Receiving Material

The electrophotographic image-receiving sheet of the present invention may be composed of the support having only a toner image-receiving layer formed thereon or, according to the use thereof, it may be composed of the support having not only the toner image-receiving layer but also additional layer(s) formed thereon. At least the toner image-receiving layer for accepting colors and black toner to form an image is formed on the support. Layers other than the toner image-forming layer which can be formed on the support are, for example, a surface-protecting layer, an intermediate layer, an under coating layer, a cushion layer, a chargeability-controlling (antistatic) layer, a reflecting layer, a color controlling layer, a storability improving layer, a releasing layer, an anti-curling layer and a smoothing layer. Two or more layers can be formed for each purpose.

In an electrophotographic image-receiving material of a transmission type, which is composed of a transparent support and a toner image-receiving layer and the like formed thereon, it is preferred that the layers on the support are also transparent. In an electrophotographic image-receiving material of a reflection type, which is composed of a reflecting support and a toner image-receiving layer and the like formed thereon, it is unnecessary that the respective layers on the support are transparent and they are rather preferably white.

The degree of whiteness is preferably at least 85% as determined by a method of JIS P 8123. It is preferred that the spectral reflectance is at least 85% in a wavelength range of 440 nm to 640 nm and that the difference between the maximum spectral reflectance and the minimum spectral reflectance is not larger than 5% in this wavelength range. It is more preferred that the spectral reflectance is at least 85% in a wavelength range of 400 to 700 nm and that the difference between the maximum spectral reflectance and the minimum spectral reflectance is not larger than 5% in the same wavelength range.

The electrophotographic image-receiving material used in the present invention can have a back layer on the opposite site of the toner image-receiving layer on the support.

In the transmission type electrophotographic image-receiving material composed of the transparent support and the toner image-receiving layer and the like formed thereon, the back layer is preferably also transparent. On the other hand, in the electrophotographic image-receiving sheet of the reflection type, which is composed of a reflecting support and a toner image-receiving layer and the like formed thereon, the back layer is not necessarily transparent and the color thereof is not limited. However, in a both-sided image-receiving sheet which forms an image on also the back surface of an electrophotographic image-receiving sheet, also the back layer is preferably white. The degree of whiteness and the spectral reflectance of the back layer are preferably at least 85% as those of the surface layer.

The electrophotographic image-receiving material of the present invention has an opacity of at least 85%, preferably at least 90%, as determined by a method of JIS P 8138.

Organic Particles Having a Glass Transition Temperature or Melting Point Lower than Fixing Temperature

Organic particles used in the present invention are those corresponding to a matting agent in the field of photographic technology. However, unlike the matting agent, they need not to roughen the surface. The organic particles can be defined to be organic discontinuous solid particles dispersible in a hydrophilic organic colloidal binder.

The organic particles usable in the present invention must have a glass transition temperature or a melting point lower than a fixing point thereof. For obtaining a transparent toner image having a gradation, the fixing temperature must be at least 50° C., and from the viewpoint of the durability of the machine, the fixing temperature is usually not higher than 200° C. Therefore, the melting point and/or glass transition temperature of the organic particles used in the present invention is preferably 200° C. or lower. Further, in view of the storability, the melting point of the organic particles used in the present invention is at least 30° C., particularly 50 to 150° C., much preferably 80 to 130° C. The suitable glass transition temperature of the organic particles used in the present invention is not higher than 160° C., preferably 100° C. The preferred glass transition temperature is 20 to 90° C. It is to be noted, however, that the preferred ranges of the melting point and/or glass transition temperature of the organic particles used in the present invention will be improved as the performance of the machine is improved.

The organic particles used in the present invention are particles of, for example, starch, cellulose esters (such as cellulose acetate propionate), cellulose ethers (such as ethyl cellulose) and synthetic resins.

Examples of the synthetic resins include water-insoluble or difficultly water-soluble synthetic polymers such as poly(meth)acrylic acid esters [e.g. polyalkyl (meth)acrylates, polyalkoxyalkyl (meth)acrylates and polyglycidyl (meth)acrylates], poly(meth)acrylamides, polyvinyl esters (e.g. polyvinyl acetate), polyacrylonitrile, polyolefins (e.g. polyethylene and polypropylene), polystyrene, benzoguanamine resin, formaldehyde-condensed polymers, epoxy resins, polyamides, polycarbonates, phenolic resins, polyvinyl carbazole and polyvinylidene chloride. Copolymers comprising a combination of the repeating units constituting the above-described polymers are also usable.

When the material constituting the organic particles is a copolymer, it may contain a small amount of a hydrophilic repeating unit. Examples of the monomers constituting the hydrophilic repeating units include acrylic acid, methacrylic acid, α,β-unsaturated dicarboxylic acids, hydroxyalkyl (meth)acrylates, sulfoalkyl (meth)acrylates and styrene sulfonic acid.

The matting agents usable as the organic particles are described in, for example, British Patent No. 1,055,713, U.S. Pat. Nos. 1,939,213, 2,221,813, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, and J. P. KOKAI Nos. Sho 49-106,821 and Sho 57-14,835. The particularly preferred organic particles are particles of polyethylene, polypropylene, polystyrene, polymethyl methacrylate and copolymers of them.

The organic particles usable in the present invention may be in the form of a mixture of two or more kinds of them.

The average particle diameter of the organic particles usable in the present invention is, for example, 0.1 to 100 μm, preferably 2 to 30μm.

The organic particles are used in an amount of, for example, 0.0001 to 1.5 g/m², preferably 0.002 to 0.8 g/m² and particularly preferably 0.0005 to 0.6 g/m². The range of the amount of the organic particles is suitably selected depending on the size and specific gravity of the particles used.

When the organic particles to be used in the present invention are incorporated into the layer, the thermal properties of the layer are changed and, therefore, it is not always necessary to roughen the surface. The preferred amount of the organic particles to be used for coating varies depending on the particle size of them. When the particle diameter is small, the number of the particles in a given weight of the coating is large and, therefore, the blocking during the storage or in the course of using can be improved even with a small amount of the particles. On the contrary, a matting agent having a large particle diameter is inclined to be used in a large amount for the coating because the number of the particles in a given weight of the coating is small.

The organic particles usable in the present invention include, for example, polyethylene products such as Flowbeads LE-1080, CL-2080, EA-209, CL-2507, CL-5007, CL-8007 and CL-12007 and Flowsen UF-1.5, UF-4, UF-20 and UF-80 (products of Sumitomo Seika Chemicals Co., Ltd.); and Techpolymer MB-8C, MB-5, MB-8, MB-12, MB-20, EMA-10, EMA-35 and EMA-35L (products of Sekisui Plastics Co., Ltd.).

### Releasing Agent

The releasing (slip) agent (those other than the organic particles used in the present invention) is used for the purpose of keeping the electrophotographic image-receiving sheet of the present invention from adhering to the fixing/heating member in the fixing step. In particular, 180° peeling strength of the toner image-receiving layer at a fixing temperature to a fixing member is preferably not higher than 0.1N/25 mm, more preferably not higher than 0.041N/25 mm. The 180° peeling strength can be determined according to a method of JIS K 6887 by using a surface material of the fixing member.

The releasing (or slip) agent usable in the present invention is selected from the group consisting of silicone compounds, fluorine compounds and waxes.

The releasing agent can be incorporated into a layer on the toner image-receiving layer side of the support or on the opposite side thereof in order to prevent the offset of the toner image-receiving layer. The releasing agent is preferably incorporated into any layer on the toner image-receiving layer side. Particularly for obtaining the effect of preventing the offset, it is preferably incorporated into a layer constituting the outmost surface of the toner image-receiving layer side. A decorating layer for decorating the surface can be formed on the outmost surface layer containing a silicone compound and/or a fluorine compound and/or a wax so far as the releasing property or offset preventing property is not damaged by pressure in the toner fixing step at a high temperature.

As the releasing agents used in the present invention, there can be generally used compounds described in “Kaitei, Wax no Seishitsu to Oyo (Property and Application of Waxes, Revised Edition)” (published by Saiwai Shobo) and “Silicone Handbook” published by The Nikkan Kogyo Shinbun Ltd. Further, silicone compounds, fluorine compounds and waxes described in the following specifications are preferred: J. P. KOKOKU Nos. Sho 59-38,581 and Hei 4-32,380; J. Patent Nos. 2,838,498 and 2,949,558; J. P. KOKAI Nos. Sho 50-117,433, 52-52,640, 57-148,755, 61-62,056, 61-62,057 and 61-118,760; and J. P. KOKAI Hei 2-42,45I, 3-41,465, 4-212,175, 4-214,750, 4-263,267, 5-34,966, 5-119,514, 6-69,602, 6-161,150, 6-175,396, 6-219,040, 6-230,600, 6-295,093, 7-36,210, 7-43,940, 7-56,387, 7-56,390, 7-64,335, 7-199,681, 7-223,362, 7-287,413, 8-184,992, 8-227,180, 8-248,671, 8-248,799, 8-248,801, 8-278,668, 9-152,739, 9-160,278, 9-185,181, 9-319,139, 9-319,143, 10-20,549, 10-48,889, 10-198,069, 10-207,116, 11-2,917, 11-44,969, 11-65,156, 11-73,049 and 11-19,454. A combination of two or more of these compounds can also be used.

The silicone compounds include silicone oils such as non-denatured silicone oils (such as dimethylsiloxane oil, methyl hydrogen silicone oil, phenyl methyl silicone oil, and commercial products such as KF-96, KF-96L, KF-96H, KF-99, KF-50, KF-54, KF-56, KF-965, KF-968, KF-994, KF-995, HIVAC F-4 and F-5 (Shin-Etsu Chemical Co., Ltd.); SH200, SH203, SH490, SH510, SH550, SH 710, SH704, SH705, SH7028A, SH7036, SM7060, SM7001, SM7706, SH7036, SH8710, SH1107 and SH8627 (Toray Dow Corning Silicone Co.); TSF400, TSF401, TSF404, TSF405, TSF431, TSF433, TSF434, TSF437, TSF450 series, TSF 451 series, TSF466, TSF458 series, TSF483, TSF484, TSF4045, TSF4300, TSF4600, YF33 series, YF-3057, YF3800, YF3802, YF-3804, YF-3807, YF-3897, XF-3905, XS69-A1753, TEX100, TEX101, TEX102, TEX103, TEX104 and TSW831 (Toshiba Silicone Co., ltd.); amino-modified silicone oils (such as KF-857, KF-858, KF-859, KF-861, KF-864 and KF-880 (Shin-Etsu Chemical Co., Ltd.), TSF4700, TSF4701, TSF4702, TSF4703, TSF4704, TSF4705, TSF4706. TEX150, TEX151 and TEX154 (Toshiba Silicone Co., Ltd.)]; carboxy-modified silicone oils [such as BY16-880 (Toray Dow Corning Silicone Co.) and TSF4770 and XF42-A9248 (Toshiba Silicone Co., ltd.)]; carbinol-modified silicone oil [such as XF42-B0970 (Toshiba Silicone Co, Ltd.)]; vinyl-modified silicone oils [such as XF40-A1987 (Toshiba Silicone Co., Ltd.)]; epoxy-modified silicone oils [such as SF8411 and SF8413 (Toray Dow Corning Silicone Co.), and TSF3965, TSF4730, TSF4732, XF42-A4439, XF42-4438, XF42-A5041, XC96-A4462, XC96-A4463, XC96-A4464 and TEX170 (Toshiba Silicone Co., Ltd.); polyether-modified silicone oils [such as KF-351(A), KF-352(A), KF-353(A), KF-354(A), KF-355(A), KF-615(A), KF-618 and KF-945(A) (Shin-Etsu Chemical Co., Ltd.); SH37746, SH3771, SF8421, SF8419, SH8400 and SF8410 (Toray Dow Corning Silicone Co.); TSF4440, TSF4441, TSF4445, TSF4446, TSF4450, TSF4452, TSF4453 and TSF4460 (Toshiba Silicone Co., Ltd.)]; silanol-modified silicone oils, methacryl-modified silicone oils, mercapto-modified silicone oils and alcohol-modified silicone oils [such as SF8427 and SF8428 (Toray Dow Corning Silicone Co.) and TSF4750, TSF4751 and XF42-B0970 (Toshiba Silicone Co., Ltd.); alkyl-modified silicone oils [such as SF8416 (Toray Dow Corning Silicone Co.), TSF410, TSF411, TSF4420, TSF4421, TSF4422, TSF4450, XF42-334, XF42-A3160 and XF42-A3161 (Toshiba Silicone Co., Ltd.)]; fluorine-modified silicone oils [such as FS1265 (Toray Dow Corning Silicone Co.) and FQF501 (Toshiba Silicone Co., Ltd.)]; silicone rubbers and fine silicone particles [such as SH851U, SH745U, SH55UA, SE4705U, SH502UA&B, SRX539U, SE6770U-P, DY38-038, DY38-047, Trefil F-201, F-202, F-250, R-900, R-902A, E-500, 1-600, E-601, E-506 and BY29-119 (Toray Dow Corning Silicone Co.); and Tospal 105, 120, 130, 145, 240 and 3120 (Toshiba Silicone Co., Ltd.)]; silicone-modified resins [olefin resins, polyester resins, vinyl resins, polyamide resins, cellulose resins, phenoxy resins, vinyl chloride/vinyl acetate resins, urethane resins, acrylic resins, styrene/acrylic resins and compounds obtained by modifying these copolymer resins with a silicone, such as Diaromer SP203V, SP712, SP2105 and SP3023 (Dainichi-seika Color & Chemicals Mfg. Co., Ltd.); Modipar FS700, FS710, FS720, FS730 and FS770 (Nippon Oils and Fats Co., Ltd.); Cymac US-270, US-350, US-352, US-380, US-413 and US-450, and Cereda GP-705, GS-30, GF-160 and GF-300 (Toagogei Chemical Industry Co., ltd.); SH997, SR2114, SH2104, SR2115, SR2202, DCI-2577, SR2317, SE4001U, SRX625B, SRX643, SRX439U, SRX488U, SH804, SH840, SR2107 and SR2115 (Toray Dow Corning Silicone Co.); YR3370, TSR1122, TSR102, TSR108, TSR116, TSR117, TSR125A, TSR127B, TSR144, TSR180, TSR187, YR47, YR3187, YR3224, YR3232, YR3270, YR3286, YR3340, YR3365, TEX152, TEX153, TEX171 and TEX172 (Toshiba Silicone Co., Ltd.)]; Toshiba Silicone Co., Ltd.)]; and reactive silicone compounds [those of addition reaction type, peroxide curing type and ultraviolet curing type, such as TSR1500, TSR1510, TSR1511, TSR1515, TSR1520, YR3286, YR3340, PSA6574, TPR6500, TPR6501, TPR6600, TPR6702, TPR6604, TPR6700, TPR6701, TPR6705, TPR6707, TPR6708, TPR6710 TPR6712, TPR6721, TPR6722, UV9300, UV9315, UV9425, UV9430, XS56-A2775, XS56-A2982, XS56-A3075, XS56-A3969, XS56-A5730, XS56-8012, XS56-B1794, SL6100, SM3000, SM3030, SM3200 and YSR3022 (Toshiba Silicone Co., Ltd.)].

The fluorine compounds include fluorine oils [Daifloyl #1, #3, #10, #20, #50 and #100 and Unidyn TG-440, TG-452, TG-490, TG-560, TG-561, G-590, TG-652, TG-670U, TG-991, TG-999, TG-3010, TG-3020 and TG-3510 (Daikin industries, Ltd.); MF-100, MF-110, MF-120, MF-180, MF-160 and MF-160E (Tohchem Products); Surfuron S-111, S-112, S-113, S-121, S-131, S-132, S-141 and S-145 (Asahi Glass Co., Ltd.); and FC-430 and FC-431 (Mitsui Fluorochemical)]; fluorine rubbers [LS63U (Toray Dow Corning Silicone Co.); fluorine modified resins [Modipar F200, F220, F600, F2020 and F3035 (Nippon Oils and Fats Co., Ltd.); Diaromer FF203 and FF204 (Dainichiseika Colour & Chemicals Mfg. Co., Ltd.); Surfuron S-381, S-383, S-393, SC-101, SC-105, KH-40 and SA-100 (Asahi Glass Co., Ltd.); EF-351, EF-352, EF-801, EF-802, EF-601, TFE, TFEA, TFEMA and PDFOH (Tohchem Products); and THV-200P (Sumitomo 3M Ltd.)]; fluorinated sulfonic acid compounds (EF-101, EF-102, EF-103, EF-104, EF-105, EF-112, EF-121, EF-122A, EF-122B, EF-122C, EF-123A, EF-123B, EF-125M, EF-132, EF-135M, EF-305, FBSA, KFBS and LFBS (Tohchem Products); fluorosulfonic acid, fluoric acid compounds and salts thereof (such as anhydrous hydrofluoric acid, dilute hydrofluoric acid, borofluoric acid, zinc borofluoride, nickel borofluoride, tin borofluoride, lead borofluoride, copper borofluoride, hydrosilicofluoric acid, potassium fluorotitanate, perfluorocaptylic acid and ammonium perfluorooctanoate); and inorganic fluorides (such as aluminum fluoride, potassium silicofluoride, potassium fluorozirconate, zinc fluoride tetrahydrate, calcium fluoride, lithium fluoride, barium fluoride, tin fluoride, potassium fluoride, acidic potassium fluoride, magnesium fluoride, fluorotitanic acid, fluorozirconic acid, ammonium hexafluorophosphate and potassium hexafluorophosphate).

The waxes include petroleum waxes such as paraffin waxes [Paraffin Wax 155, 150, 140, 135, 130, 125, 120 and 115, HNP-3, HNP-5, HNP-9, HNP-10, HNP-11, HNP-12, HNP-14G, SP-0160, SP-0145, SP-1040, SP-1035, SP-3040, SP-3035, NPS-8070, NPS-L-70, OX-2151, OX-2251, EMUSTAR-0384 and EMUSTAR-0136 (Nippon Seiro Co., Ltd.); Seirozole 686, 428, 651-A, A, H-803, B-460, E-172, 866, K-133, Hydrin D-337 and E-139 (Chukyo Yushi); and 125° paraffin, 125° FD, 130° paraffin, 135′ paraffin, 135° H, 140° paraffin, 140° N, 145° paraffin and paraffin wax M (Nisseki Mitsubishi Oil Co., Ltd.)); microcrystalline waxes [Hi-Mic-2095, Hi-Mic-3090, Hi-Mic-1080, Hi-Mic-1070, Hi-Mic-2065, Hi-Mic-1045, Hi-Mic-2045, EMUSTAR-0001 and EMUSTAR-042X (Nippon Seiro Co., Ltd.); Serozole 967, M (Chukyo Yushi) and 155 Microwax and 180 Microwax (Nisseki Mitsubishi Oil Co., Ltd.); and petrolatum [OX-1789, OX-0450, OX-0650B, OX-0153, OX-261BN, OX-0851, OX-0560, OX-0750B, JP-1500, JP-056R and JP-01P (Nippon Seiro Co., Ltd.); vegetable waxes such as carnauba wax [EMUSTAR-0413 (Nippon Seiro Co., Ltd.); and Serozole 524 (Chukyo Yushi)], castor oil [purified castor oil of Ito Seiu], rape seed oil, soybean oil, haze wax, cotton wax, rice wax, sugar cane wax, candelilla wax, Japan wax, Jojoba oil; animal waxes such as bees wax, lanolin, whale wax, whale oil and wool wax; mineral waxes including natural waxes such as montan wax, montan ester wax, ozocerite and ceresine; and synthetic waxes such as fatty acid esters [Sansocizer DOA, AN-800, DINA, DIDA, DOZ, DOS, TOTM, TITM, E-PS, nE-PS, E-PO, E-4030, E-6000, E-2000H, E-9000H, TCP and C-1100 (New Japan Chemical Co., Ltd.)]; synthetic hydrocarbons such as polyethylene waxes [Polyron A, 393 and H-481 (Chukyo Yushi); Sunwax B-310, E-330, E-250P, LEL-250, LEL-800 and LEL-400P (Sanyo Chemical Industries, Ltd.); polypropylene wax (Biscol 330-P, 550-P and 660-P (Sanyo Chemical Industries, Ltd.)]; and Fischer-Tropsch waxes [FT100 and FT-0070 (Nippon Seiro Co., Ltd.); acid amide compounds and acid imide compounds [such as stearic acid amide; anhydrous phthalic acid imide; and Serozole 920 and B-495, Himicron G-270 and G-110, Hydrin D-757 (Chukyo Yushi); modified waxes such as amine-modified polypropylene [QN-7700 (Sanyo Chemical Industries, Ltd.), acrylic acid-modified wax, fluorine-modified wax, olefin-modified wax, urethane-type waxes [NPS-6010 and HAD-5090 (Nippon Seiro Co., Ltd.)] and alcohol-type waxes [NPS-9210, NPS-9215, OX-1949 and XO-020T (Nippon Seiro Co., Ltd.)], hydrogenated waxes such as hardened castor oil (Caster Wax of Ito Seiyu), castor oil derivatives [dehydrated castor oil DCO, DCO Z-1 and DCO Z-3, castor oil fatty acid CO-FA, ricinoleic acid, dehydrated castor oil fatty acid DCO-FA, dehydrated castor oil fatty acid epoxy ester D-4 ester, castor oil urethane acrylate CA-10, CA-20 and CA-30, castor oil derivatives MINERASOL S-74, S-80, S-203, S-42X and S-321, specified condensed fatty acids of castor oil MINERASOL RC-2, EC-17, RC-55 and RC-335; specified condensed fatty acid esters of castor oil MINERASOL LB-601, LB-603, LB-604, LB-702, LB-703, #11 and L-164 (Ito Seiyu)], stearic acid (such as 12-hydroxystearic acid of Ito Seiyu), lauric acid, myristic acid, palmitic acid, behenic acid, sebacic acid (such as sebacic acid of Ito Seiyu), undecylenic acid (such as undecylenic acid of Ito Seiyu), heptylic acid (such as heptylic acid of Ito Seiyu), maleic acid, highly maleinized oils (such as HIMALEIN DC-15, LN-10, 00-15, DF-20 and SF-20 of Ito Seiyu)], blown oils [such as Senobol #10, #30, #60, R-40 and S-7 of Ito Seiyu), cyclopentadienyl function-introduced oils (such as CP oil and CP oil-S of Ito Seiyu).

The releasing agent includes derivatives, oxides, purified products and mixtures of those described above. They may have a reactive substituent.

In the present invention, the releasing agent is used in an amount of, for example, 0.1 to 10% by mass, preferably 0.3 to 8.0% by mass, and particularly preferably 0.5 to 5.0% by mass, based on the layer into which the releasing agent is to be incorporated.

Because a releasing agent is hardly soluble in organic solvents, it is preferred that an aqueous dispersion thereof is prepared and then a dispersion thereof with a thermoplastic resin solution is prepared and used. A wax slip agent or releasing agent is present in the form of fine particles in the thermoplastic resin. In this case, the amount of the releasing agent is 5 to 10,000 mg/m², preferably 50 to 5,000 mg/m². When an oil for preventing the offset to the fixing member in the fixing part is not used or, in other words, in case of so-called oil-less fixing, the amount of the releasing agent used may be, for example, 30 to 3,000 mg/m², preferably 100 to 1,500 mg/m².

### Toner Image-Receiving Layer

The toner image-receiving layer used in the present invention has functions of receiving an image-forming toner from a developing drum or an intermediate transfer medium by (static) electricity, pressure, etc. in the transferring step and fixing the image by heat, pressure, etc. in the fixing step.

The toner image-receiving layer used in the present invention can contain various additives in addition to the thermoplastic resin so far as the additives do not impair the function of the toner image-receiving layer.

The thickness of the toner image-receiving layer is at least a half, preferably 1 to 8 times as much as the particle diameter of the toner used. The thickness of the toner image-receiving layer is preferably as described in J. P. KOKAI Nos. Hei 5-216,322 and 7-301,939.

The toner image-receiving layer preferably has one, more preferably two or more, and most preferably all of the following physical properties:

(1) The toner image-receiving layer has a Tg (glass transition temperature) in the range of 30° C. to toner Tg+20° C.
(2) The toner image-receiving layer has T1/2 (½ method softening point) of 60 to 200° C., preferably 80 to 170° C. The ½ method softening point is defined to be a temperature at which the difference between piston stroke at the initiation of the flowing and that at the end of the flowing is ½, when heat increase is caused at a prescribed constant rate using a prescribed device and condition while a prescribed extrusion pressure is imposed, after a thermal inertia time of, for example, 300 sec. at an initial set temperature (for example, 50° C.).
(3) Tfb (temperature at which the flowing begins) of the toner image-receiving layer is 40 to 200° C. Preferably Tfb of the toner image-receiving layer is not higher than toner Tfb+50° C.
(4) Temperature at which the viscosity of the toner image-receiving layer is 1×10⁵ CP is not lower than 40° C. and lower than that of the toner.
(5) The storage elastic modulus (G′) at a fixing temperature of the toner image-receiving layer is 1×10² to 1×10⁵ Pa and the loss elastic modulus (G″) thereof is 1×10² to 1×10⁵ Pa.
(6) The loss tangent (G″/G′), which is the ratio of the loss elastic modulus (G″) to the storage elastic modulus (G′) at a fixing temperature of the toner image-receiving layer, is 0.01 to 10.
(7) The storage elastic modulus (G′) at a fixing temperature of the toner image-receiving layer is −50 to +2500 as compared with the storage elastic modulus (G″) at the fixing temperature of the toner.
(8) The inclination angle on the image-receiving layer of the molten toner is not higher than 50°, particularly not higher than 40°.

The toner image-forming layers are preferably those satisfying physical properties described in Japanese Patent No 2,788,358 and J. P. KOKAI Nos. Hei 7-248,637, Hei 8-305,067 and Hei 10-239,889.

The physical property of item (1) above can be determined with a differential scanning calorimeter (DSC). The physical properties of items (2) to (4) above can be determined with Flow Tester CFT-500 or 500D (Shimadzu Corporation). The physical properties of items (5) to (7) above can be determined with a rotary rheometer (such as Dinamic Analyzer RADII of Rheometric Co.). The physical property of item (8) above can be determined by a method described in J. P. KOKAI No. Hei 8-334,916 with a contact angle meter of Kyowa Kaimen Kagaku K.K.

The thermoplastic resins usable for the toner image-receiving layer of the present invention are not particularly limited 80 far as they are capable of being deformed at the fixing temperature and also capable of receiving the toner. The thermoplastic resin used for the toner image-receiving layer preferably belongs to the same group as that of a resin used as the binder for the toner. Because polyester resins, styrene/acrylic acid ester copolymers, styrene/methacrylic acid ester copolymers, etc. are used for forming the toner in many cases, the thermoplastic resins used for the toner image-receiving layer in the present invention are preferably polyester resins, styrene/acrylic acid ester copolymers, styrene/methacrylic acid ester copolymers, etc. Concretely, when a coated paper is used as the above-described support, a thermoplastic resin which is the same as that described above with reference to the thermoplastic resins used for forming the coated paper is preferably used.

The thermoplastic resin is incorporated in an amount of usually at least 20% by mass, preferably 30 to 100% by mass, based on the toner image-receiving layer.

The thermoplastic resins usable for forming the toner image-receiving layer are preferably those having physical properties described in J. P. KOKOKU Nos. Hei 5-127,413, Hei 8-194,394, Hei 8-334,915, Hei 8-334,916, Hei 9-171,265 and Hei 10-221,877.

The thermoplastic resins used for forming the toner image-receiving layer of the present invention are those capable of satisfying the requirement of the above-described physical properties of the image-forming layer after the formation of the image-receiving layer. More preferred thermoplastic resins are those capable of satisfying the requirement of the above-described physical properties of the toner image-receiving layer even when they are used alone. Two or more resins having different physical properties can be used together.

The thermoplastic resin used for forming the toner image-receiving layer is preferably the one having a molecular weight larger than that of the thermoplastic resin used for forming the toner. However, this relationship in the molecular weight is not always desirable depending on the relationship between the thermodynamic properties of the toner resin and that of the thermoplastic resin used for forming the toner image-receiving layer. For example, when the softening temperature of the thermoplastic resin used for forming the toner image-receiving layer is higher than that of the toner resin, it is occasionally preferred that the molecular weight of these resins is equal or that of the thermoplastic resin used for forming the toner image-receiving layer is lower.

It is also preferred to use a mixture of resins having the same compositions but different average molecular weight as the thermoplastic resin for forming the toner image-receiving layer. The molecular weights of the thermoplastic resins used for forming the toner are preferably those described in J. P. KOKAI No. Hei 8-334,915.

The molecular weight distribution of the thermoplastic resin used for forming the toner image-receiving layer is preferably broader than that of the thermoplastic resin used for forming the toner.

The thermoplastic resins used for forming the toner image-receiving layer may be soluble in water. The water-soluble thermoplastic resins are not particularly limited in respect of its composition, bonding structure, molecular structure, molecular weight, molecular weight distribution, form, etc. so far as they are soluble in water. A necessary condition for obtaining a water-soluble thermoplastic resin is, for example, that the resin has a water-soluble group such as a hydroxyl group, a carboxylic acid group, an amino group, an amido group or an ether group.

Examples of the water-soluble thermoplastic resins are given in Research Disclosure No. 17,643 (page 26), No. 18,716 (page 651) and 307,105 (pages 873 to 874), and J. P. KOKAI No. Sho 64-13,546 (pages 71 to 75). Specifically, the water-soluble thermoplastic resins usable herein are, for example, vinylpyrrolidone/vinyl acetate copolymer, styrene/vinylpyrrolidone copolymer, styrene/maleic anhydride copolymer, water-soluble polyesters, water-soluble polyurethane, water-soluble nylon and water-soluble epoxy resin.

When a water-insoluble thermoplastic resin is used for forming the toner image-receiving layer, for example, an aqueous dispersion thereof is applied to the support. The aqueous dispersion is suitably selected from among acrylic resin emulsion, polyvinyl acetate emulsion, SBR (styrene/butadiene/rubber) emulsion, polyester resin emulsion, polystyrene resin emulsion, urethane resin emulsion, etc. A combination of two or more of them is also usable. When a gelatin is used, it can be selected from among gelatin treated with lime, gelatin treated with an acid and so-called delimed gelatin having a reduced calcium content.

When the binder for the toner is a polyester resin, the resin for forming the toner image-receiving layer is preferably a polyester resin.

Polyester resins available on the market are, for example, Vylon 290, Vylon 200, Vylon 280, Vylon 300, Vylon 103, Vylon GK-140 and Vylon GK-130 (products of Toyobo Co., Ltd.); Tafton NE-382, Tafton U-5, ATR-2009 and ATR-2010 Kao Corporation); Erither UE3500, UE3210 and XA-8153 (products of Unitika Ltd.); and Polyester TP-220 and R-188 (products of The Nippon Synthetic Chemical Industry, Co., Ltd.). The acrylic resins available on the market are, for example, Dianal SE-5437, SE-5102, SE-5377, SE-5649, SE-5466, SE-5482, HR-169, 124, HR-1127, HR-116, HR-113, HR-148, HR-131, HR-470, HR-634, HR-606, HR-607, LR-1065, 574, 143, 396, 637, 162, 469, 216, BR-50, BR-52, BR-60, BR-64, BR-73, BR-75, BR-77, BR-79, BR-80, BR-83, BR-85, BR-87, BR-88, BR-90, BR-98, BR-95, BR-100, BR-101, BR-102, BR-105, BR-106, BR-107, BR-108, BR-112, BR-113, BR-115, BR-116 and BR-117 (products of Mitsubishi Rayon Co., Ltd.); Eslec P SE-0020, SE-0040, SE-0070, SE-0100, SE-1010 and SE-1035 (products of Sekisui Chemical Co., Ltd.); and ST95 and ST120 (products of Sanyo Chemical Industries, Ltd.); and FM601 (a product of Mitsui Kagaku). Preferred polyester emulsions available on the market are, for example, Vironal MD-1250 and MD-1930 (products of Toyobo Co,. Ltd.); Plascoat Z-446, Z-465 and RZ-96 (products of Goo Chemical Industries Co., Ltd.); ES-611 and ES-670 products of Dainippon Ink and Chemicals, Inc.); and Pesresin A-160P, A-210, A-515 GB and A-620 products of Takamatsu Yushi).

The film-forming temperature of the thermoplastic resin is preferably not lower than room temperature for the storage before the printing and it is preferably not higher than 100° C. for the fixing of the toner particles.

The toner image-receiving layer used in the present invention may contain various additives for improving the thermodynamic properties of this layer, in addition to the thermoplastic resin. The additives include, for example, plasticizers, fillers, crosslinking agents, emulsifying agents and dispersing agents.

As the plasticizers, well-known plasticizers for resins are usable without any limitation. The plasticizers have a function of controlling the fluidization or softening of the toner image-receiving layer by heat and/or pressure in the step of fixing the toner.

The plasticizers can be selected with reference to “Kagaku Binran (Handbook of Chemistry)” (edited by Nihon Kagaku-kai and published by Maruzen Co., Ltd.), “Kaso-zai—Sono Riron to Ouyou—(Plasticizers—The Theory and Application Thereof—)” (edited by Koichi Murai and published by Saiwai Book Publishing Co.), “Kasozai no Kenkyu (Study of Plasticizers), Part 1 and Part 2 (edited by Kohbunshi Kagaku Kyokai”, and “Handbook, Chemicals to be Incorporated into Rubber/Plastic” (edited by Rubber Digest Co.).

The plasticizers include those described as high-boiling organic solvents and thermal solvents; esters described in, for example, J. P. KOKAI Nos. Sho 59-83,154, 59-178,451, 59-178,453, 59-178,454, 59-178,455, 59-178,457, 62-174,754, 62-245,253, 61-209,444, 61-200,538, 62-9,348, 62-30,245 and 62-136,646 and J. P. KOKAI No. Hei 2-235694 (such as phthalic acid esters, phosphoric acid esters, fatty acid esters, abietic acid esters, adipic acid esters, sebacic acid esters, azelaic acid esters, benzoic acid esters, butyric acid esters, epoxidized fatty acid esters, glycolic acid esters, propionic acid esters, trimellitic aid esters, citric acid esters, sulfonic acid esters, carboxylic acid esters, succinic acid esters, maleic acid esters, fumaric acid esters, phthalic acid esters and stearic acid esters), amides (such as fatty acid amides and sulfoamides), ethers, alcohols, lactones and polyethyleneoxy compounds.

The plasticizers are usable in the form of a mixture with the resin.

When the plasticizers can be considered as falling within the category of a releasing (slipping) effect, they are meant not to have such effect.

Polymers having a relatively low molecular weight can be used as the plasticizer. The molecular weight of the polymer is preferably lower than that of the binder resin to be plasticized. The molecular weight is not higher than 15,000, preferably not higher than 5,000. When a polymer plasticizer is used, it is preferably a polymer belonging to the same group as that of the binder resin to be plasticized. For the plasticization of a polyester resin, a polyester of a low molecular weight is preferred. Oligomers are also usable as the plasticizer.

In addition to the above-described compounds, commercially available plasticizers are usable. They include, for example, Adecacizer PN-170 and PN-1430 (Asahi Denka Kogyo K.K.); PARAPLEX-G-25, G-30 and G-40 (C. P. HALL Co.); and Ester Gum 8L-JA, Ester R-95, Pentalin 4851, PK115, 4820, 830, Luizol 28-JA, Picolastic A75, Picotex LC and Crystalex 3085 (Rika Hercules).

The plasticizer is optionally usable for relieving the stress or strain caused when the toner particles are embedded in the toner image-receiving layer (such as physical strains caused by elastic power, viscosity or the like, and strains caused by material balance of the molecule, main chain of binder, pendant part, etc.).

The plasticizer may be microscopically dispersed in the toner image-receiving layer or microscopically phase-separated in island-sea-type, or it may be thoroughly mixed with another component such as a binder to form a solution.

The plasticizer is preferably used in an amount of, for example, 0.001 to 90% by mass, preferably 0.1 to 60% by mass, and particularly preferably 1 to 40% by mass, based on the toner image-receiving layer.

The plasticizer is usable also for the purposes of controlling the slipping property (improvement in transfer easiness by the reduction in friction), improving the offset in the fixing part (release of the toner or layer to the fixing part) and control of the curl balance and control of the electrification (formation of toner electrostatic image).

As the organic or inorganic fillers (other than the organic particles and releasing agents used in the present invention) which can be incorporated into the toner image-receiving layer of the present invention, if desired, those well-known as reinforcing agent, filler or reinforcing agent for the binder resins are usable. The fillers can be selected with reference to “Binzan Gomu/Plastic Haigoh Yakuhin (Handbook of Chemicals to be Incorporated into Rubbers and Plastics)” (edited by Rubber Digest Co.), “Plastic Haigohzai, Kiso to Oyo (Additives to Plastics, Base and Application, New Edition) (published by Taisei Co.) and “Filler Handbook” (published by Taisei Co.).

The fillers usable herein include various inorganic fillers (or pigments). The inorganic pigments are, for example, silica, alumina, titanium dioxide, zinc oxide, zirconium oxide, mica-like iron oxide, white lead, lead oxide, cobalt oxide, strontium chromate, molybdenum pigments, smectites, magnesium oxide, calcium oxide, calcium carbonate and mullite. As the fillers, silica and alumina are particularly preferred. Two or more fillers can be used together.

As the fillers, those having a small particle diameter are preferred. When the a filler having a large particle diameter is used, the surface of the toner image-receiving layer is easily roughened.

The silica is divided into groups of spherical silica and amorphous silica. Silica can be synthesized by a dry method, wet method or aerogel method. The hydrophobic silica particles may be surface-treated with trimethylsilyl group or a silicone. The silica is preferably colloidal silica. The average particle diameter of the silica is 4 to 120 nm, preferably 4 to 90 nm.

The silica is preferably porous. The average pore diameter of the porous silica is preferably 50 to 500 nm. The average pore volume per mass of the porous silica is preferably, for example, 0.5 to 3 ml/g.

Alumina includes anhydrous alumina and alumina hydrate. Crystal types of anhydrous alumina usable herein are α, β, γ, δ, ζ, η, θ, κ, ρ and χ. Alumina hydrate is preferred to anhydrous alumina. The alumina hydrates usable herein are alumina monohydrate and trihydrates. Alumina monohydrate include pseudo-boehmite, boehmite and diaspore. Alumina trihydrates include gibbsite and bayerite. The average particle diameter of alumina is, for example, 4 to 300 nm, preferably 4 to 200 nm. Alumina is preferably porous. The average pore diameter of the porous alumina is preferably, for example, 60 to 500 nm. The average pore volume per mass of the porous alumina is preferably, for example, 0.3 to 3 ml/g.

Alumina hydrate can be synthesized by a sol/gel method wherein ammonia is added to an aluminum salt solution to precipitate it or by a method wherein an alkali aluminate is hydrolyzed. Anhydrous alumina can be obtained by dehydrating alumina hydrate by heating.

The amount of the filler is preferably 5 to 2,000% by mass based on the dry mass of the binder in a layer to which the filler is to be added.

A crosslinking agent can be optionally incorporated into the toner image-receiving layer of the present invention for the purpose of controlling the storability, thermoplasticity, etc. of the toner image-receiving layer. The crosslinking agents usable herein are compounds having at least two reactive groups selected from among epoxy group, isocyanato group, aldehyde group, active halogen groups, active methylene group, acetylene group and other well-known reactive groups.

Alternatively, compounds having at least two groups capable of forming a bond such as a hydrogen bond, an ion bond and a coordination bond are also usable as the crosslinking agents.

Compounds well-known as a coupling agent, a curing agent, a polymerizing agent, a polymerization accelerator, a coagulating agent, a film-forming agent, a film-forming assistant, etc. for resins are also usable as the crosslinking agent. The coupling agents are, for example, chlorosilanes, vinylsilanes, epoxysilanes, aminosilanes, alkoxyaluminum chelates and titanate coupling agents. Known coupling agents described in Binran Gomu/Plastic Haigoh Yakuhin (Handbook of Chemicals to be Incorporated into Rubbers and Plastics)” (edited by Rubber Digest Co.) are also usable.

A static charge controlling agent is preferably incorporated into the toner image-receiving layer of the present invention for controlling the toner transfer and adhesion and also for preventing the electrostatic adhesion of the toner image-receiving layer. The static charge controlling agents are those known in the art. They include surfactants such as cationic surfactants, anionic surfactants, amphoteric surfactants and nonionic surfactants, high-molecular electrolytes and conductive metal oxides.

The static charge controlling agents include cationic antistatic agents such as quaternary ammonium salts, polyamine derivatives, cation modified polymethyl methacrylate and cation modified polystyrene; anionic antistatic agents such as alkyl phosphates and anionic polymers; and non-ionic antistatic agents such as fatty acid esters and polyethylene oxides. However, the static charge controlling agents are not limited to them.

When the toner has a negative electric charge, the electric charge controlling agent to be incorporated into the toner image-receiving layer is preferably cationic or nonionic.

The conductive metal oxides are, for example, ZnO, TiO₂, SnO₂, Al₂O₃, In₂O₃, SiO₂, MgO, BaO and MoO₃. Those conductive metal oxides are usable either alone or in the form of a complex oxides of them. The metal oxides may further contain other elements. For example, ZnO can contain Al, In or the like, TiO₂ can contain Nb, Ta or the like, and SnO₂ can contain Sb, Nb, halogen elements or the like (doping).

The toner image-receiving layer used in the present invention preferably has a surface electric resistance in the range of 1×10⁵ to 1×10¹⁵Ω (under conditions of 25° C., 65% RH). When it is below 1×10⁶Ω, the amount of the toner is insufficient when the toner is transferred to the toner image-receiving layer, and the obtained toner image density is inclined to be low. On the contrary, when the surface electric resistance is above 1×10¹⁵Ω, the electric charge is formed excessively in the transfer, the toner is not sufficiently transferred, the density of the image is low, dust is adhered to the electrophotographic image-receiving sheet with static electricity while the sheet is handled, and misfeeding, double feeding, discharge mark and toner transfer missing are caused unfavorably.

The optimum surface electric resistance of a transparent toner image-receiving layer is 10¹⁰ to 10¹³ Ω/cm², preferably 5×10¹⁰ to 5×10¹² Ω/cm². The amount of the antistatic agent used is such that the surface electric resistance will be in this range. The surface electric resistance on the back surface of the support (opposite to the toner image-receiving layer) is 5×10⁸ to 3.2×10¹⁰ Ω/cm², preferably 1×10⁹ to 1×10¹⁰ Ω/cm².

The surface electric resistance is determined according to JIS K 6911. Namely, water content of a sample is controlled by keeping it in an atmosphere having a temperature of 20° C. and a humidity of 65% for at least 8 hours, then applying an electric current to the sample under 100V with R8340 (Advantest Corporation) under the same environmental conditions as above for 1 minute and then the surface electric resistance is determined.

The toner image-receiving layer of the electrophotographic image-receiving material of the present invention may contain a fluorescent brightening agent, white pigment, coloring pigment, dye, etc. for improving the image quality, particularly degree of whiteness.

The fluorescent brightening agents are compounds having an absorption band in a near-ultraviolet zone and emit the fluorescence in the range of 400 to 500 nm. Well-known fluorescent brightening agents are usable without any limitation. Preferred fluorescent brightening agents are, for example, compounds described in The Chemistry of Synthetic Dyes (edited by K. Veen Rataraman), Volume V, Chapter 8. Concretely, they include stilbene compounds, coumarin compounds, biphenyl compounds, benzoxazoline compounds, naphthalimide compounds, pyrazoline compounds and carbostyryl compounds. Examples of them include White Falfar PSN, PHR, HCS, PCS and B (Sumitomo Chemical Co., Ltd.) and UVITEX-OB (Ciba-Geigy).

As the white pigments, the inorganic pigments (titanium oxide, calcium carbonate, etc.) described above with reference to the fillers are usable. The coloring pigments include various pigments described in, for example, J. P. KOKAI No. Sho 63-44653 and azo pigments (azo lakes such as Carmine 6B and Red 2B; insoluble azo pigments such as Monoazo Yellow, Disazo Yellow, Pyrazolo Orange and Vulcan Orange; and condensed azo pigments such as Chromophthal Yellow and Chromophthal Red)), polycyclic pigments (phthalocyanine pigments such as Copper Phthalocyanine Blue and Copper Phthalocyanine Green; dioxazine pigments such as Dioxazine Violet; isoindolinone pigments such as Isoindolinone Yellow; threne pigments such as perylene, perinone, flavanthrone and thioindigo), lake pigments (Malachite Green, Rhodamine B, Rhodamine G and Victoria Blue B) and inorganic pigments such as oxides, titanium dioxide, red iron oxide, sulfates (precipitated barium sulfate), carbonates (precipitated calcium carbonate), silicates (hydrous silicates and anhydrous silicates) and metal powders (aluminum powder, bronze powder, zinc powder, carbon black, chrome yellow and Prussian blue).

As the dyes, various well-known dyes are usable. The oil-soluble dyes include anthraquinone compounds and azo compounds. Examples of the water-insoluble dyes include vat dyes such as C. I. Vat Violet 1, C. I. Vat Violet 2, C. I. Vat Violet 9, C. I. Vat Violet 13, C. I. Vat Violet 21, C. I. Vat Blue 1, C. I. Vat Blue 3, C. I. Vat Blue 4, C. I. Vat Blue 6, C. I. Vat Blue 14, C. I. Vat Blue 20 and C. I. Vat Blue 35; disperse dyes such as C. I. Disperse Violet 1, C. I. Disperse Violet 4, C. I. Disperse Violet 10, C. I. Disperse Blue 3, C. I. Disperse Blue 7 and C. I. Disperse Blue 58; and oil-soluble dyes such as C. I. Solvent Violet 13, C. I. Solvent Violet 14, C. I. Solvent Violet 21 and C. I. Solvent Violet 27; and C. I. Solvent Blue 11, C. I. Solvent Blue 12, C. I. Solvent Blue 25 and C. I. Solvent Blue 55.

Colored couplers used for the silver salt photography are also preferably used.

The toner image-receiving layer of the electrophotographic image-receiving sheet of the present invention preferably has a high degree of whiteness. As for the degree of whiteness, L* value in CIE 1976 (L*a*b*) color space is at least 80, preferably at least 85 and more preferably at least 90. The tinge of the white color is desirably as neutral as possible. As for the tinge of the white color, the value of (a*)2+(b*)2 in L*a*b* space is preferably not higher than 50, more preferably not higher than 18 and most preferably not higher than 5.

The toner image-receiving layer of the present invention preferably has a high gloss. As for the surface gloss, 45° surface gloss in the whole zone ranging from white (no toner) to black (maximum toner concentration) is preferably not lower than 60, more preferably not lower than 75 and most preferably not lower than 90. However, the surface gloss is preferably not higher than 110. When it is higher than 110, the gloss is like a metallic gloss which is unsuitable for the image quality.

The surface gloss can be determined according to JIS Z 8741.

The smoothness of the toner image-receiving layer used in the present invention is preferably high. As for the degree of smoothness, the arithmetic mean roughness (Ra) in the whole zone ranging from white (no toner) to black (maximum tuner density) is preferably not higher than 3 μm, more preferably not higher than 1 μm and most preferably not higher than 0.5 μm.

The arithmetic mean roughness can be determined according to JIS B 0601, B 0651 and B 0652.

The toner image-receiving layer used in the present invention may contain various antioxidants, agents for preventing aging, agents for preventing deterioration, agents for preventing deterioration caused by ozone, ultraviolet absorbers, light stabilizers, antiseptics and antifungal agents for improving the stability of the output image and also the stability of the image-receiving layer per se.

The antioxidants include, for example, chroman compounds, coumaran compounds, phenol compounds (such as hindered phenol), hydroquinone derivatives, hindered amine derivatives and spiroindane compounds. The antioxidants usable herein are those described in J. P. KOKAI Sho 61-159644.

The agents for preventing aging are, for example, those described on pages 76 to 121 of Binran Gomu/Plastic Haigoh Yakuhin (Handbook of Chemicals to be Incorporated into Rubbers and Plastics)” (edited by Rubber Digest Co. in 1993).

The ultraviolet absorbers are, for example, benzotriazole compounds (U.S. Pat. No. 3,533,794), 4-thiazolidone compounds (U.S. Pat. No. 3,352,681), benzophenone compounds (J. P. KOKAI No. Sho 46-2784) and ultraviolet absorbing polymers (J. P. KOKAI No. Sho 62-260152).

The metal complexes are, for example, those described in U.S. Pat. Nos. 4,241,155, 4,245,018 and 4,254,195, and J. P. KOKAI Nos. Sho 61-88,256, Sho 62-174,741, Sho 63-199,248, Hei 1-75,568 and Hei 1-74,272.

Further, ultraviolet absorbers and photo stabilizers described on pages 122 to 137 of Binran Gomu/Plastic Haigoh Yakuhin (Handbook of Chemicals to be Incorporated into Rubbers and Plastics)” (edited by Rubber Digest Co.) are also preferably used.

The toner image-receiving layer in the present invention can further contain known photographic additives. The photographic additives are described in Research Disclosure (hereinafter referred to as “RD”) Nos. 17,643 (December, 1978), 18,716 (November, 1979) and 307,105 (November, 1989). The positions in RD are summarized in the following table.

| Additive | RD 17648 | RD 18,716 | RD 307,105 |
|---|---|---|---|
| Whitening | p. 24 | p. 648, | p. 868 |
| agent | | right column | |
| Stabilizer | pp. 24-25 | p. 649, | pp. 868-870 |
| | | right column | |
| Light | pp. 25-26 | p. 649, | p. 873 |
| absorber UV | | right column | |
| absorber | | | |
| Dye image | p. 25 | p. 650, | p. 872 |
| stabilizer | | right column | |
| Hardening | p. 26 | p. 651, | pp. 874-875 |
| agent | | left column | |
| Binder | p. 26 | p. 651, | pp. 873-874 |
| | | left column | |
| Plasticizer, | p. 27 | p. 650, | p. 876 |
| lubricant | | right column | |
| Coating aid | pp. 26-27 | p. 650, | pp. 875-876 |
| Surfactant | | right column | |
| Antistatic | p. 27 | p. 650, | pp. 876-877 |
| agent | | right column | |

### Protecting Layer

A protecting layer can be provided on the surface of the toner image-receiving layer of the electrophotographic image-receiving material of the present invention for the purposes of protecting the surface, improving the storability and handleability, imparting possibility of writing ability, improvement in sheet passing ability through machines and imparting anti-offset property. The protecting layer may be composed of one layer or two or more layers. The protecting layer may contain various thermoplastic resins and thermosetting resins as binders. The resin is preferably the same as that used in the toner image-receiving layer. However, the thermodynamic properties and electrostatic properties of the protective layer are not necessarily the same as those of the toner image-receiving layer, and the respective layers can have optimum properties.

The protecting layer can contain the above-described various additives usable for the toner image-receiving layer. In particular, the protecting layer may contain the organic particles and releasing agents used in the present invention and also other additives such as plasticizers, and the like. Additives which will be described below are usable also for layers other than the protecting layer.

The outmost surface layer (for example, the surface-protecting layer when it is provided) of the electrophotographic image-receiving material of the present invention preferably has a high compatibility with the toner from the viewpoint of the fixing property. Specifically, the angle of contact with the molten toner is preferably 0 to 40° or the like.

The outmost surface layer may include an inorganic matting agent. The inorganic matting agent may be various, well-known ones. The inorganic matting agents include oxides (such as silicon dioxide, titanium oxide, magnesium oxide and aluminum oxide), alkaline earth metal salts (such as barium sulfate, calcium carbonate and magnesium sulfate) and silver halides (such as silver chloride and silver bromide) and glasses.

The inorganic matting agents are described in the specifications of West German Patent No. 2,529,321, British Patent Nos. 760,775 and 1,260,772 and U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245 and 4,029,504.

### Back Layer

The electrophotographic image-receiving sheet of the present invention can have a back layer on the surface on the side opposite to the toner image-receiving layer for the purposes of providing output ability at the backside of the support, improving the backside image output quality, improving the curl balance and improving the sheet passing ability through the machines.

The composition of the back layer may be the same as that of the toner image-receiving layer for the purpose of improving the both sides output ability. The back layer may contain various additives described above with reference to the toner image-receiving layer. An electrification controlling agent is suitable as the additive. The back layer may comprise either one layer or two or more layers.

The back layer may be an oil-absorbing layer when a releasing oil is used for a fixing roller or the like for preventing offset in the fixing step. The back layer may also contain an inorganic matting agent as stated above.

### Other Optional Layers

The electrophotographic image-receiving material of the present invention can have a contact improving layer for improving the contact between the support and the toner image-receiving layer. The contact improving layer may contain various additives described above, particularly the crosslinking agent. The electrophotographic image-receiving material of the present invention may have a cushion layer between the contact improving layer and the toner image-receiving layer for improving the toner acceptability.

The electrophotographic image-receiving material of the present invention can have an intermediate layer in addition to the above-described various layers. The intermediate layer can be formed between the support and the contact improving layer, between the contact improving layer and the cushion layer, between the cushion layer and the toner image-receiving layer or between the toner image-receiving layer and the storability improving layer. In an electrophotographic image-receiving material comprising the support, toner image-receiving layer and intermediate layer, the intermediate layer can be formed between the support and the toner image-receiving layer as a matter of course. The organic particles used in the present invention can be optionally incorporated in those layers.

### Toner for Color Electrophotography

The electrophotographic image-receiving material of the present invention is used in combination with a toner or toner particles in the printing or copying. The toner is generally composed of a colorant and a binder resin as main components.

The colorants usable for the toner are well-known colorants without any limitation. The typical examples of the colorants are carbon black, Aniline Blue, Calcoil Blue, Chrome Yellow, Ultramarine Blue, Du Pont Oil Red, Quinoline Yellow, Methylene Blue Chloride, Phthalocyanine Blue, Malachite Green Oxalate, Lamp Black, Rose Bengal, C, I. Pigment Red 48:1, C, I. Pigment Red 122, C, I. Pigment Red 57:1, C, I. Pigment Yellow 97, C, I. Pigment Yellow 12, C, I. Pigment Yellow 17, C. I. Pigment Blue 15:1 and C.I. Pigment Blue 15:3. The colorant content is, for example, 2 to 8% by mass based on the toner. When the colorant content is less than 2% by mass, the coloring power is easily weakened and, on the contrary, when it is more than 8% by mass, the transparency of the color toner is easily reduced.

The binder resins usable for the toner are homopolymers and copolymers such as styrenes, e.g., styrene and chlorostyrene; monoolefins, e.g., ethylene, propylene, butylene and isoprene; vinyl esters, e.g., vinyl acetate, vinyl propionate, vinyl benzoate and vinyl butyrate; α-methylene aliphatic monocarboxylic acid esters, e.g., methyl acrylate, ethyl acrylate, butyl acrylate, dodecyl acrylate, octyl acrylate, phenyl acrylate, methyl methacrylate, ethyl methacrylate, butyl methacrylate and dodecyl methacrylate; vinyl ethers, e.g., vinyl methyl ether, vinyl ethyl ether and vinyl butyl ether; and vinyl ketones, e.g., vinyl methyl ketone, vinyl hexyl ketone and vinyl isopropenyl ketone.

Particularly typical binder resins include polystyrene resin, polyester resin, styrene/alkyl acrylate copolymers, styrene/alkyl methacrylate copolymers, styrene/acrylonitrile copolymer, styrene/butadiene copolymer, styrene/maleic anhydride copolymer, polyethylene resin and polypropylene resin. They further include polyurethane resin, epoxy resin, polyamide resin and modified rosin. In those resins, a polyester resin of the same series as that used for the toner image-receiving layer of the electrophotographic image-receiving material is preferred.

The physical properties of the binder resin for the toner used in the present invention are preferably the same as those of the resin used for the toner image-receiving layer of the electrophotographic image-receiving material of the present invention. Specifically, the binder resin for the toner preferably has a storage elastic modulus of 10 to 300 Pa as determined at an angular frequency of 10 rad/sec at 150° C.

The binder resin for the toner preferably has a sharp melting property as disclosed in J.P. KOKAI No. Hei 8-305,067.

The average particle diameter of the toner usable in combination with the electrophotographic image-receiving material of the present invention is, for example, 3 to 15 μm, preferably 4 to 8 μm. The storage elastic modulus G′ of the toner per se (determined at an angular frequency of 10rad/sec) at 150° C. is 10 to 200 Pa.

The toner used in combination with the electrophotographic image-receiving sheet of the present invention may contain an additive. Inorganic powders and organic particles are used as the additive. The inorganic particles are, for example, SiO₂, TiO₂, Al₂O₃, CuO, ZnO, SnO₂, Fe₂O₃, MgO, BaO, CaO, K₂O, Na₂O, ZrO, CaO.SiO₂, K₂O.(TiO)ₙ, Al₂O₃.2SiO₂, CaCO₃, MgCO₈, BASO₄ and MgSO₄. The organic particles are powders of fatty acids and derivatives thereof and metal salts thereof, and also powders of resins such as fluororesins, polyethylene resins and acrylic resins. The average particle diameter of those powders is, for example, 0.01 to 5 μm, preferably 0.1 to 2 μm.

### Image-Forming Apparatus and Method

The method for forming an image on the electrophotographic image-receiving material of the present invention is not particularly limited. Various electrophotographic methods can be employed.

For example, a color image can be preferably formed on the electrophotographic image-receiving material of the present invention. A colored image can be formed with an electrophotographic apparatus capable of forming a full-colored image. An ordinary electrophotographic apparatus is composed of an image-receiving sheet sending part, a latent image-forming part and a developing part placed close to the latent image-forming part. In some apparatus, an intermediate toner image-transfer part is placed close to the latent image-forming part and the image-receiving material sending part at the center of the apparatus.

For improving the image quality, an adhesion transfer method or a heat-supporting transfer method to be conducted in place of or in combination with the electrostatic transfer or bias roller transfer method is known. The structures of the transfer apparatus is described in, for example, J.P. KOKAI Nos. Sho 63-113,576 and Hei 5-341,666. The heat-supporting transfer method wherein an intermediate transfer belt is used is preferred particularly when a toner having a small particle diameter (not larger than 7 μm) is used. The intermediate belt is, for example, an endless belt made of electro-formed nickel. This belt has a thin silicone or fluorine film on the surface thereof so as to have a releasing property. Preferably, the intermediate belt used after the toner transfer to the electrophotographic image-receiving material or in the latter half of the stage of the transfer is provided with a cooling device. With the cooling device, the toner is cooled to a temperature lower than the softening point of the binder or lower than the glass transition temperature thereof, and then the toner is efficiently transferred to the electrophotographic image-receiving material to make the release thereof from the intermediate belt possible.

The fixing is an important step for the gloss and smoothness of the final image. For the fixing, a method wherein a heating pressure roller is used and another method wherein a belt is used are known. From the viewpoints of the image qualities such as gloss and smoothness, the belt fixing method is preferred. As for this method, a method described in J. P. KOKAI No. Hei 11-352,819 wherein an oil-less type belt is used and also a method described in J.P. KOKAI Nos. Hei 11-231,671 and Hei 5-341,666 wherein the secondary transfer and the fixing are performed at the same time are known.

The surface of the fixing belt is preferably treated with a surface-treating agent containing silicone, fluorine or a mixture of them for preventing the peeling of the toner or the offset of the toner component. In the latter half of the fixing step, a cooling apparatus for the belt is preferably provided to facilitate the release of the electrophotographic image-receiving material. The cooling temperature is preferably lower than the softening point or glass transition point of the toner binder and the polymer in the toner image-receiving layer of the electrophotographic image-receiving material. On the other hand, in the initial stage of the fixing, the temperature must be elevated to a point at which the toner image-receiving layer of the electrophotographic image-receiving material or the toner is sufficiently softened. Specifically, the cooling temperature is practically preferably 30 to 70° C., and the temperature in the initial stage of the fixing is 100 to 180° C.

The following Examples and Comparative Examples will further illustrate the present invention, which by no means limit the scope of the present invention.

In the following Examples and Comparative Examples, percentages and parts are given by mass.

### Examples 1 to 14 and Comparative Examples 1 to 5

### Support A

A mixture of a high-density polyethylene and a low-density polyethylene (PE) in a ratio of 7:3 was applied to the surface of a toner image-receiving layer side of a wood free paper having a basis weight of 160 g and a thickness of 151 μm, so as to have a thickness of 13 μm, and also to the back surface of this paper so as to have a thickness of 15 μm, thereby to form a laminate. The polyethylene layers thus formed were treated by corona discharge. Then, a composition for forming a subbing layer was applied to the both surfaces with a wire coater so that the weight of the coating after drying would be about 0.1 g/m² and then dried to obtain support A.

TABLE 1

| Layer | | | | |
|---|---|---|---|---|
| structure | | | | Film |
| of | | | | thickness |
| support A | Layer composition of Support A | | | (μm) |
| Subbing | Gelatin | 100 | parts | 0.1 |
| layer on | | | | |
| the surface | | | | |
| PE layer | High-density polyethylene | 70 | parts | 13 |
| on the | (MI = 8 g/10 min, density 0.950) | | | |
| surface | Low-density polyethylene | 30 | parts | |
| (glossy) | (MI = 7 g/10 min, density 0.923) | | | |
| | Anatase-type titanium dioxide | 2.0 | g/m² | |
| Base | Wood free paper (basis weight of | | | 151 |
| paper | pulp tissue: 160 g/m²) | | | |
| PE layer | High-density polyethylene | 70 | parts | 15 |
| on the | (MI = 8 g/10 min, density 0.950) | | | |
| back | Low-density polyethylene | 30 | parts | |
| surface | (MI = 7 g/10 min, density 0.923) | | | |
| (matte) | | | | |
| Subbing | Gelatin | 100 | parts | 0.1 |
| layer on | | | | |
| the back | | | | |
| surface | | | | |
| | | | | 179.2 |

### <Composition for Forming Subbing Layer>

| | |
|---|---|
| Gelatin | 5 g |
| Water | 1,000 g |

Then, the following composition for forming the back layer was applied to the back surface of Support A in such an amount that the dry film weight would be 4.5 g/m² with a bar coater and then dried to form a back layer.

### <Composition for Forming Back Layer>

| | |
|---|---|
| Polyester resin (Vironal MD-1200, Toyobo Co., Ltd.) | 90 g |
| Matting agent (Epostar L15, Nippon | 50 g |
| Shokubai Kagaku Kogyo Co., Ltd.) | |
| Water | 10000 g |

Note)
Epostar L15 used as the matting agent is in the form of polymer particles having an average diameter of 12 μm, which comprise benzoguanamine/formaldehyde condensate having no melting point or glass transition temperature and which start the decomposition at 300° C. in the differential thermal analysis.

Then, the following composition for forming the toner image-receiving layer was applied to the back surface of support A in such an amount that the dry film weight would be 8 g/m² with a wire coater and then dried to form a toner image-receiving layer.

### <Composition for Forming Toner Image-Receiving Layers

| | | |
|---|---|---|
| Polyester resin (Tafton U-5, Kao Corporation) | 400 | g |
| Titanium dioxide (Typaque A-220, Isihara | 60 | g |
| Sangyo Kaisha, Ltd.) | | |
| TPP (Daihachi Kagaku) | 34.8 | g |
| Organic particles (see Table 2) | x | g |
| Methyl ethyl ketone | 800 | g |

Note)
TPP represents triphenyl phosphate used as the plasticizer.

Then, the following composition for forming a top coating layer as a protecting layer was applied, if necessary, to the surface of the toner image-receiving layer in such an amount that the dry film weight would be 0.8 g/m², and then dried to form a protecting layer.

### <Top Coating Layer>

| | |
|---|---|
| A515GB (Takamatsu Yushi) | 1790 g |
| LX814 (Nippon Zeon Co., Ltd.) | 491 g |
| Water | 8900 g |
| SH7028A (Toray Silicone Dow Corning) | 740 g |

Note)
A515GB is a water-dispersible polyester resin.
LX814 is a water-dispersible acrylic resin used as the binder.
SH7028A is a silicone rubber having a siloxane structure and used as the releasing agent.

### Evaluation Method

### 1) Evaluation of Layer Peeling and Blocking

Two unprinted films were put together in such a manner that the glossy surfaces of toner image receiving layers of them (unprinted) were contacted with each other. In the same manner, a glossy surface of the toner image-receiving layer was contacted with the back surface of another unprinted film; white, gray (image R=G=B=50%) or black image surfaces of prints were contacted with each other. A load of 78 hPa (80 gf/cm³) was applied to them, and they were kept under conditions of 30° C. and 20% RH for one week. The layer peeling and blocking of the surfaces were observed. When the peeling and blocking were recognized, the results were shown as x, and when they were not recognized, the results were shown as ◯.

### 2) Evaluation of Image Quality

The electrophotographic image-receiving sheet was cut into a size of A4. A lady portrait image on the sheet was judged by 30 people. When at least 25 people judged it to be photographically excellent, the results were shown as ◯; when at least 20 people judged it to be excellent, the results were shown as Δ; and when less than 20 people judged it to be so, the results were x.

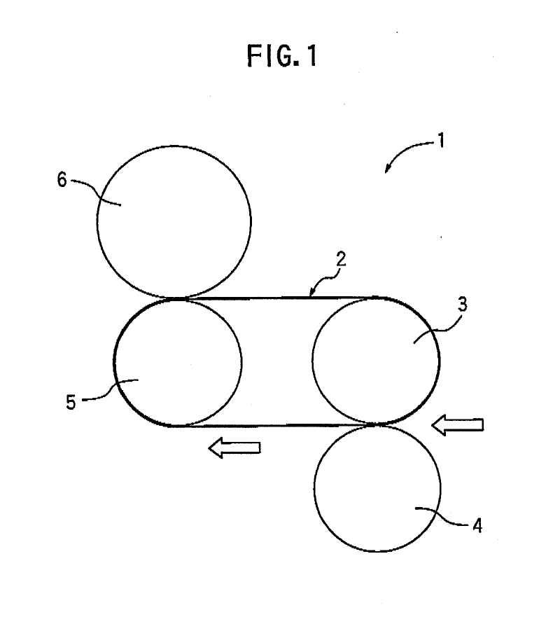

The printer used was a color laser printer (DocuColor 1250-PF) of Fuji Xerox Co., Ltd. except that a fixing belt system as shown in FIG. 1 was used.

Namely, in fixing belt system 1 shown in FIG. 1, a fixing belt 2 is provided on a heating roller 3 and a tension roller 5. A cleaning roller 6 is provided on the tension roller 5 via the fixing belt 2. A pressure roller 4 is provided on the heating roller 3 via the fixing belt 2. An electrophotographic image-receiving sheet having a toner latent image is inserted between the heating roller 3 and the pressure roller 4 on the right side in FIG. 1, then fixed, transferred with the fixing belt 2 and cleaned with the cleaning roller 6.

In this fixing belt system, the transfer speed of the fixing belt 2 is 30 mm/sec; the nip pressure between the heating roller 3 and the pressure roller 4 is 0.2 MPa (2 kgf/cm²); and the setting temperature of the heating roller 3 is 150° C., which corresponds to the fixing temperature. The setting temperature of the pressure roller 4 is 120° C.

Following Table 2 shows the structures of the electrophotographic image-receiving sheets. Table 3 shows the results of the evaluation of the properties of the electrophotographic image-receiving sheets determined by the above-described evaluation method before and after the printing

TABLE 2

| | | Average |
|---|---|---|
| | | diameter of |
| | | organic |
| | | particles |
| | Material of organic particles | (μm) |
| Example 1 | Flowbeads CL-2080 (Sumitomo Seika | 12 |
| | Chemicals Co., Ltd.) | |
| Example 2 | Flowbeads CL-2080 (Sumitomo Seika | 12 |
| | Chemicals Co., Ltd.) | |
| Example 3 | Flowsen UF-80 (Sumitomo Seika | 25 |
| | Chemicals Co., Ltd.) | |
| Example 4 | Flowsen UF-80 (Sumitomo Seika | 25 |
| | Chemicals Co., Ltd.) | |
| Example 5 | Flowsen UF-80 (Sumitomo Seika | 25 |
| | Chemicals Co., Ltd.) | |
| Example 6 | Techpolymer MB-8C (Sekisui Plastics | 8 |
| | Co., Ltd.) | |
| Example 7 | Techpolymer MB-8C (Sekisui Plastics | 8 |
| | Co., Ltd.) | |
| Example 8 | Flowbeads CL-2080 (Sumitomo Seika | 12 |
| | Chemicals Co., Ltd.) | |
| Example 9 | Flowbeads CL-2080 (Sumitomo Seika | 12 |
| | Chemicals Co., Ltd.) | |
| Example 10 | Flowsen UF-80 (Sumitomo Seika | 25 |
| | Chemicals Co., Ltd.) | |
| Example 11 | Flowsen UF-80 (Sumitomo Seika | 25 |
| | Chemicals Co., Ltd.) | |
| Example 12 | Flowsen UF-80 (Sumitomo Seika | 25 |
| | Chemicals Co., Ltd.) | |
| Example 13 | Techpolymer MB-8C (Sekisui Plastics | 8 |
| | Co., Ltd.) | |
| Example 14 | Techpolymer MB-8C (Sekisui Plastics | 8 |
| | Co., Ltd.) | |
| Comp. Ex. 1 | none | |
| Comp. Ex. 2 | none | |
| Comp. Ex. 3 | Techpolymer MBX-20 (Sekisui Plastics | 20 |
| | Co., Ltd.) | |
| Comp. Ex. 4 | Techpolymer MBX-20 (Sekisui Plastics | 20 |
| | Co., Ltd.) | |
| Comp. Ex. 5 | Techpolymer MBX-20 (Sekisui Plastics | 20 |
| | Co., Ltd.) | |

| | Melting point or glass | Amount of | |
|---|---|---|---|
| | transition temp. of organic | organic | Protecting |
| | particles (° C.) | particles (xg) | layer |
| Example 1 | 105 (melting point) | 0.5 | no |
| Example 2 | 105 (melting point) | 2.0 | no |
| Example 3 | 105 (melting point) | 0.5 | no |
| Example 4 | 105 (melting point) | 1.0 | no |
| Example 5 | 105 (melting point) | 2.0 | no |
| Example 6 | 130 (glass transition temp.) | 2.0 | no |
| Example 7 | 130 (glass transition temp.) | 5.0 | no |
| Example 8 | 105 (melting point) | 0.5 | yes |
| Example 9 | 105 (melting point) | 2.0 | yes |
| Example 10 | 105 (melting point) | 0.5 | yes |
| Example 11 | 105 (melting point) | 1.0 | yes |
| Example 12 | 105 (melting point) | 2.0 | yes |
| Example 13 | 130 (glass transition temp.) | 2.0 | yes |
| Example 14 | 130 (glass transition temp.) | 5.0 | yes |
| Comp. Ex. 1 | | | no |
| Comp. Ex. 2 | | | yes |
| Comp. Ex. 3 | Heat-resistant particles | 2.0 | no |
| | decomposable at 280° C. or | | |
| | higher | | |
| Comp. Ex. 4 | Heat-resistant particles | 5.0 | yes |
| | decomposable at 280° C. or | | |
| | higher | | |
| Comp. Ex. 5 | Heat-resistant particles | 5.0 | yes |
| | decomposable at 280° C. or | | |
| | higher | | |

TABLE 3

| | Blocking prevention of | | | | | |
|---|---|---|---|---|---|---|
| | unprinted film | | | | | |
| | Toner | | | | | |
| | image | Glossy | Blocking prevention of printed film | | | |
| | receiving | surface and | | | | Image |
| | layers | back surface | White | Gray | Black | quality |
| Ex. 1 | ◯ | ◯ | ◯ | ◯ | ◯ | ◯ |
| Ex. 2 | ◯ | ◯ | ◯ | ◯ | ◯ | ◯ |
| Ex. 3 | ◯ | ◯ | ◯ | ◯ | ◯ | ◯ |
| Ex. 4 | ◯ | ◯ | ◯ | ◯ | ◯ | ◯ |
| Ex. 5 | ◯ | ◯ | ◯ | ◯ | ◯ | ◯ |
| Ex. 6 | ◯ | ◯ | ◯ | ◯ | ◯ | ◯ |
| Ex. 7 | ◯ | ◯ | ◯ | ◯ | ◯ | ◯ |
| Ex. 8 | ◯ | ◯ | ◯ | ◯ | ◯ | ◯ |
| Ex. 9 | ◯ | ◯ | ◯ | ◯ | ◯ | ◯ |
| Ex. 10 | ◯ | ◯ | ◯ | ◯ | ◯ | ◯ |
| Ex. 11 | ◯ | ◯ | ◯ | ◯ | ◯ | ◯ |
| Ex. 12 | ◯ | ◯ | ◯ | ◯ | ◯ | ◯ |
| Ex. 13 | ◯ | ◯ | ◯ | ◯ | ◯ | ◯ |
| Ex. 14 | ◯ | ◯ | ◯ | ◯ | ◯ | ◯ |
| Comp. | X | X | X | X | X | ◯ |
| Ex. 1 | | | | | | |
| Comp. | X | X | X | X | X | ◯ |
| Ex. 2 | | | | | | |
| Comp. | ◯ | ◯ | ◯ | ◯ | ◯ | X |
| Ex. 3 | | | | | | |
| Comp. | ◯ | ◯ | ◯ | ◯ | ◯ | X |
| Ex. 4 | | | | | | |
| Comp. | ◯ | ◯ | ◯ | ◯ | ◯ | X |
| Ex. 5 | | | | | | |

It is apparent from the results shown above that, according to the present invention, the electrophotographic image-receiving sheets free from roughness or peeling and having a high smoothness and an excellent photographic property are obtained. Even when these sheets are stored in piles, the adhesion or blocking between the sheets is not caused.

### Examples 15 to 28 and Comparative Examples 6 to 11

### Support B

A wood free paper (basis weight of the pulp tissue: 160 g/m²) having a center line average height shown in Table 4, produced by incorporating 1.1 g/m³ of water-dispersible anatase-type titanium dioxide, was used as the base paper. A blend of a high-density polyethylene (PE) (MI=8 g/10 min, density: 0.950 g/cm³) and a low-density polyethylene (PE) (MI=7 g/10 min, density: 0.923 g/cm³) at a weight ratio of 7/3 was extruded by an extrusion coating method (310° C.) to form a back polyethylene (PE) layer having a thickness of 15 μm.

Then, a blend (containing 2.0 g/m² of anatase-type titanium dioxide) of a high-density polyethylene (PE) (MI=10 g/10 min, density: 0.950 g/cm³) and a low-density polyethylene (PE) (MI=7 g/10 min, density: 0.923 g/cm³) at a weight ratio of 7/3 was extruded on the surface of the above-described wood free paper by the extrusion coating method in the same manner as that described above to form a surface polyethylene (PE) layer having a thickness of 13 μm.

TABLE 4

| Layer | | | | |
|---|---|---|---|---|
| structure | | | | Film |
| of | | | | thickness |
| support | Layer composition | | | (μm) |
| Subbing | Gelatin | 100 | parts | 0.1 |
| layer on | | | | |
| the surface | | | | |
| PE layer | High-density polyethylene | 70 | parts | 13 |
| on the | (MI = 8 g/10 min, density 0.950) | | | |
| surface | Low-density polyethylene | 30 | parts | |
| (glossy) | (MI = 7 g/10 min, density 0.923) | | | |
| | Anatase-type titanium dioxide | 2.0 | g/m² | |
| Base | Wood free paper (basis weight | | | 151 |
| paper | of pulp tissue: 160 g/m²) | | | |
| PE layer | High-density polyethylene | 70 | parts | 15 |
| on the | (MI = 8 g/10 min, density 0.950) | | | |
| back | Low-density polyethylene | 30 | parts | |
| surface | (MI = 7 g/10 min, density 0.923) | | | |
| (matte) | | | | |
| Subbing | Gelatin | 100 | parts | 0.1 |
| layer on | | | | |
| the back | | | | |
| surface | | | | |
| | | | | 179.2 |

The PE layers on the surface and back surface of the support shown in Table 4 were treated by corona discharge. Then, the following composition for forming a subbing layer was applied to both of the surface and back surface with a wire coater in such a manner that the thickness after drying would be 0.1 μm, and then dried to form a subbing layer each on the surface and back surface. The following composition for the back layer was applied to the back layer in such an amount that the coating amount after drying would be 4.5 g/m², and then dried to form a back layer.

### <Composition for Forming Subbing Layer on the Surface>

| | |
|---|---|
| gelatin | 5 g |
| water | 95 g |

### <Composition for Forming Back Layer>

| | |
|---|---|
| Polyester resin (Vironal MD-1200, Toyobo Co., Ltd.) | 100 g |
| Matting agent (Eposter L15, Nippon | 30 g |
| Shokubai Kagaku Kogyo Co., Ltd.) | |
| Ethanol | 60 g |
| Water | 200 g |

Then, the following composition A or B containing a releasing agent shown in Table 5 below and forming a toner image-receiving layer was applied to the subbing layer on the surface in such an amount that the dry film weight would be 15 g/m² with a wire coater and then dried to form the products of Examples 15 to 28 and Comparative Examples 6 to 9.

### <Composition A for Forming Toner Image-Receiving Layer>

| | |
|---|---|
| Polyester resin (Tafton U-5, Kao Corporation) | 100 g |
| Releasing agent (Table 5) | x g |
| Triphenyl phosphate | 9 g |
| Titanium dioxide (Typaque (registered trade mark) | 15 g |
| A-220, Ishihara Sangyo Kaisha, Ltd.) | |
| Methyl ethyl ketone | 160 g |

### <Composition B for Forming Toner Image-Receiving Layer>

| | |
|---|---|
| Water-dispersible polyester resin (KZA-7049, Unitika Ltd.) | 100 g |
| Releasing agent (Table 5) | x g |
| Titanium dioxide (Typaque (registered trade mark) | 0.9 g |
| A-220, Ishihara Sangyo Kaisha, Ltd.) | |
| Methanol | 30 g |
| Water | 10 g |

TABLE 5

| | Center | | | |
|---|---|---|---|---|
| | line | | | |
| | average | Composition | | |
| | height of | of toner | Releasing agent incorporated into toner image- | |
| | support | image | receiving layer | |
| | surface | receiving | | Amount |
| | (μm) | layer | Kind | (x g) |
| Example | 0.5 | A | Carnauba wax | 4 |
| 15 | | | | |
| Example | 1.0 | A | Carnauba wax | 4 |
| 16 | | | | |
| Example | 1.5 | A | Carnauba wax | 4 |
| 17 | | | | |
| Example | 5.0 | A | Carnauba wax | 4 |
| 18 | | | | |
| Example | 0.5 | A | Cymac US-380 (silicone resin of Toagosei | 15 |
| 19 | | | Chemical Industry Co.,) | |
| Example | 0.5 | A | Cymac US-380 (silicone resin of Toagosei | 30 |
| 20 | | | Chemical Industry Co.,) | |
| Example | 0.5 | A | Diaromer SP2105 silicone resin of | 40 |
| 21 | | | (Dainichiseika Colour & Chemicals Mgf. | |
| | | | Co., Ltd.) | |
| Example | 0.5 | A | Modipar (fluororesin of Nippon Oils and | 20 |
| 22 | | | Fats Co., Ltd.) | |
| Example | 1.0 | A | Modipar (fluororesin of Nippon Oils and | 30 |
| 23 | | | Fats Co., Ltd.) | |
| Example | 1.0 | A | KF-857 (Amino-modified silicone resin of | 2 |
| 24 | | | Shin-Etsu Chemical Co., Ltd.) | |
| Example | 1.0 | B | Cymac US-380 (silicone resin of Toagosei | 15 |
| 25 | | | Chemical Industry Co.,) | |
| Example | 0.5 | B | Serozole 524 (carnauba wax of Chukyo | 15 |
| 26 | | | Yushi) | |
| Example | 0.5 | B | Serozole 524 (carnauba wax of Chukyo | 30 |
| 27 | | | Yushi) | |
| Example | 1.0 | B | SH7028A (dimethylsiloxane of Toray Dow | 1 |
| 28 | | | Corning Silicone) | |
| Comp. Ex. 6 | 7.5 | B | Serozole 524 (carnauba wax of Chukyo | 15 |
| | | | Yushi) | |
| Comp. Ex. 7 | 15.0 | B | Serozole 524 (carnauba wax of Chukyo | 15 |
| | | | Yushi) | |
| Comp. Ex. 8 | 0.5 | A | none | 0 |
| Comp. Ex. 9 | 1.0 | A | none | 0 |

| | Evaluation | | |
|---|---|---|---|
| | Sheet passing | | |
| | property | Gloss | Touch |
| Example 15 | ◯ | ◯ | ◯ |
| Example 16 | ◯ | ◯ | ◯ |
| Example 17 | ◯ | ◯ | ◯ |
| Example 18 | ◯ | Δ | ◯ |
| Example 19 | ◯ | ◯ | ◯ |
| Example 20 | ◯ | ◯ | ◯ |
| Example 21 | ◯ | ◯ | ◯ |
| Example 22 | ◯ | ◯ | ◯ |
| Example 23 | ◯ | ◯ | ◯ |
| Example 24 | Δ | ◯ | ◯ |
| Example 25 | ◯ | ◯ | ◯ |
| Example 26 | ◯ | ◯ | ◯ |
| Example 27 | ◯ | ◯ | ◯ |
| Example 28 | Δ | ◯ | ◯ |
| Comp. Ex. 6 | ◯ | X | ◯ |
| Comp. Ex. 7 | ◯ | X | ◯ |
| Comp. Ex. 8 | X | not | ◯ |
| | | determined | |
| Comp. Ex. 9 | X | not | ◯ |
| | | determined | |

The electrophotographic image-receiving sheet thus produced was cut into a size of A4. The obtained piece of the sheet was set in a color laser printer (DocuPrint C-620) (Fuji Xerox Co., Ltd.), and an image from a computer was printed thereon. Four images, i.e., white, gray (image R=G=B=50%), black and a lady portrait, were printed.

### Evaluation

20 sheets of each image were printed. When all the sheets could be passed, the results are shown as ◯ in Table 5 above. When 1 to 5 sheets could not be passed, the results are shown as Δ. When 6 or more sheets could not be passed, the results are shown as x.

The state of the surface of the toner image-receiving layer was macroscopically evaluated before the printing. The results are shown in Table 5 above, wherein ◯ represents that the excellent glossy surface was obtained, Δ represents that even though the print had some unevenness, it was tolerable after the printing, and x represents that the unevenness remained after the printing.

50 panelists compared the touch of the print with that of an A4 color photograph (Fuji Photo Film Co., Ltd.). When the panelists felt that touch of the former was like that of the photograph, the results were shown by ◯. When 1 to 5 panelists felt some difference between them, the results were shown by Δ. When 6 or more panelists felt some difference between them, the results were shown by x. The results are shown in Table 5 above.

The prints obtained in Examples 15 to 28 were excellent in all of the passing property, gloss and touch.

After the printing, the printing was also possible on the back surface.

When the samples were tried to be printed with the following commercial color laser printers, all the sample could be passed, and the results as shown in Table 5 were obtained: full color laser printers of Fuji Xerox Co., Ltd. (such as DocuColor 1250CP, A color 629 and Color Laser Wind CLW-3320PS), color Copiers of XEROX (DocuColor 5750), LP-8000C of Seiko Epson, COLOR PAGEPRESTO N4-ST of Casio Computer Co., Ltd., COLOR LASER SHOT LBP-2030 of Canon Inc., magicolor 2 of QMS Japan, Color LaserBit KL-2010 of Konica Corporation, JX-8200 of Sharp Corporation, BEAMSTAR-RW of Hitachi, Ltd. and Color Page Pro PS of Minolta Camera Co., Ltd.

On the other hand, in Comparative Examples 5 and 6 wherein the center line average height on the support surface is higher than 5 μm, the gloss was poor. In Comparative Examples 7 and 8 wherein the releasing agent was not used, the sheet passing property was poor.

### Examples 29 to 0.39 and Comparative Examples 10 and 11

The same support as that used in Table 4 was used in the same manner as that in Examples 15 to 28 and Comparative Examples 5 to 9. Namely, a subbing layer was formed on the surface, and a back layer as will be shown below was formed on the back surface. Composition C having the following composition and forming a toner image-receiving layer was applied with a wire coater so that the amount of the coating after drying would be 15 g/m², and then dried. Then, Composition D having the following composition and forming the top layer (protecting layer) was applied to a toner image-receiving layer with a wire coater so that the amount of the coating after drying would be 1 g/m², and then dried to form the products of Examples 29 to 39 and Comparative Examples 10 and 11.

### <Composition C for Forming Toner Image-Receiving Layer>

| | |
|---|---|
| Polyester resin (Tafton U-5, Kae Corporation) | 100 g |
| Triphenyl phosphate | 9 g |
| Titanium dioxide [Typaque (registered trade name) | 15 g |
| A-220, Ishihara Sangyo Kaisha, Ltd.)] | |
| Methyl ethyl ketone | 160 g |

### <Composition D for Forming Top (Protecting)Layer>

| Water-dispersible resin (Table 6) | z | g |
|---|---|---|
| Releasing agent (Table 6) | u | g |
| Water | 400 | g |

TABLE 6

| | Center | | | |
|---|---|---|---|---|
| | line | | | |
| | average | Composition | | |
| | height | of toner | Top (protecting) layer | |
| | of | image | Binder resin | |
| | support | receiving | | Amount |
| | (μm) | layer | Kind | (z g) |
| Example | 0.5 | C | KZA-7049 (polyester resin of Unitika | 400 |
| 29 | | | Ltd.) | |
| Example | 0.5 | C | KZA-7049 (polyester resin of Unitika | 400 |
| 30 | | | Ltd.) | |
| Example | 0.5 | C | KZA-7049 (polyester resin of Unitika | 165 |
| 31 | | | Ltd.) | |
| Example | 0.5 | C | Peresresin A-515GB (polyester resin of | 165 |
| 32 | | | Takamatu Resin)/LX-814 (acrylic resin of | |
| | | | Nippon Zeon Co., Ltd.) | |
| Example | 1.0 | C | Peresresin A-515GB (polyester resin of | 165 |
| 33 | | | Takamatu Resin)/LX-814 (acrylic resin of | |
| | | | Nippon Zeon Co., Ltd.) | |
| Example | 1.0 | C | Peresresin A-515GB (polyester resin of | 165 |
| 34 | | | Takamatu Resin)/LX-814 (acrylic resin of | |
| | | | Nippon Zeon Co., Ltd.) | |
| Example | 1.0 | C | Peresresin A-515GB (polyester resin of | 165 |
| 35 | | | Takamatu Resin)/LX-814 (acrylic resin of | |
| | | | Nippon Zeon Co., Ltd.) | |
| Example | 0.5 | C | Peresresin A-515GB (polyester resin of | 165 |
| 36 | | | Takamatu Resin)/LX-814 (acrylic resin of | |
| | | | Nippon Zeon Co., Ltd.) | |
| Example | 0.5 | C | KZA-7049 (polyester resin of Unitika | 400 |
| 37 | | | Ltd.) | |
| Example | 0.5 | C | KZA-7049 (polyester resin of Unitika | 400 |
| 38 | | | Ltd.) | |
| Example | 0.5 | C | KZA-7049 (polyester resin of Unitika | 400 |
| 39 | | | Ltd.) | |
| Comp. | 0.5 | C | Peresresin A-515GB (polyester resin of | 400 |
| Ex. 10 | | | Takamatu Resin)/LX-814 (acrylic resin of | |
| | | | Nippon Zeon Co., Ltd.) | |
| Comp. | 0.5 | C | Peresresin A-515GB (polyester resin of | 165 |
| Ex. 11 | | | Takamatu Resin)/LX-814 (acrylic resin of | |
| | | | Nippon Zeon Co., Ltd.) | |

Top (protecting) layer
Releasing agent

| | | Amount |
|---|---|---|
| | Kind | (z g) |
| Example 29 | Serozole 524 (carnauba wax of Chukyo | 50 |
| | Yushi) | |
| Example 30 | Serozole 524 (carnauba wax of Chukyo | 100 |
| | Yushi) | |
| Example 31 | SH7028 (dimethylsiloxane of Toray | 20 |
| | Dow Corning Silicone) | |
| Example 32 | SH7028 (dimethylsiloxane of Toray | 20 |
| | Dow Corning Silicone) | |
| Example 33 | SH7028 (dimethylsiloxane of Toray | 20 |
| | Dow Corning Silicone) | |
| Example 34 | TEX151 (amino-modified silicone oil of | 20 |
| | Toshiba Silicone Co., Ltd.) | |
| Example 35 | TEX170 (epoxy-modified silicone oil of | 20 |
| | Toshiba Silicone Co., Ltd.) | |
| Example 36 | Serozole 524 (carnauba wax of Chukyo | 20 |
| | Yushi) | |
| Example 37 | Serozole 651-A (carnauba wax of | 50 |
| | Chukyo Yushi) | |
| Example 38 | Polyron 393 (polyethylene wax of | 5 |
| | Chukyo Yushi | |
| Example 39 | Himicron (stearamide of Chukyo | 50 |
| | Yushi) | |
| Comp. Ex. 10 | (none) | 0 |
| Comp. Ex. 11 | (none) | 0 |

The results of the evaluation carried out in the same manner as that of Examples 15 to 28 and Comparative Examples 6 to 9 are shown in the following Table 7. The results were similar to those described above.

TABLE 7

| | Evaluation | | |
|---|---|---|---|
| | Sheet passing | | |
| | property | Gloss | Touch |
| Example 29 | Δ | ◯ | ◯ |
| Example 30 | ◯ | ◯ | ◯ |
| Example 31 | ◯ | ◯ | ◯ |
| Example 32 | Δ | ◯ | ◯ |
| Example 33 | ◯ | ◯ | ◯ |
| Example 34 | ◯ | ◯ | ◯ |
| Example 35 | ◯ | ◯ | ◯ |
| Example 36 | ◯ | ◯ | ◯ |
| Example 37 | ◯ | ◯ | ◯ |
| Example 38 | ◯ | ◯ | ◯ |
| Example 39 | ◯ | ◯ | ◯ |
| Comp. Ex. 10 | X | not determined | ◯ |
| Comp. Ex. 11 | X | not determined | ◯ |

### Examples 40 to 47

Supports a-1 and a-2 each having the following layer structure were prepared in the same manner as that in Example 15.

TABLE 8

| | | | Film |
|---|---|---|---|
| Support | | Amount | thickness |
| a-1 | Layer structure of support | (parts) | (μm) |
| Surface | NK ester U-108A (monomer) (Shin- | 10 | 10 |
| layer | Nakamura Chemical) | | |
| (glossy) | Dipentaerythritol tetraacrylate | 90 | |
| | Irgacure 651 (Ciba Specialty Chemicals) | 10 | |
| | (irradiation with 400 W mercury lamp at a | | |
| | distance of 4 cm for 5seconds) | | |
| | (center line average height on the surface: | | |
| | 0.2 μm) | | |
| Base | Wood free paper | | 151 |
| paper | (basis weight of pulp tissue: | | |
| | 160 g/m²) | | |
| Back | High density polyethylene | | |
| layer | (MI = 8 g/10 min, density = 0.950) | | |

| | |
|---|---|
| Total film thickness | 176 |

TABLE 9

| | | Film |
|---|---|---|
| Support | | thickness |
| a-2 | Layer structure of support | (μm) |
| Surface | Polypropylene | 30 |
| layer | (MI = 15 g/10 min, Melting point = 159° C.) | |
| (glossy) | (center line average height on the surface: 0.5 μm) | |
| Base | Wood free paper | 151 |
| paper | (basis weight of pulp tissue: 160 g/m²) | |
| Back layer | Polypropylene | 30 |
| (matte) | (MI = 15 g/10 min, Melting point = 159° C.) | |

| | |
|---|---|
| Total film thickness | 211 |

The both surfaces of Support a-1 or a-2, or one of other Supports a-3 to a-6 shown below were subjected to corona treatment in Examples 26 to 29 as shown in Table 7 given below. Then composition C (free of releasing agent) for forming toner image layer-receiving layer as described above or composition E or F (containing the releasing agent) for forming toner image-receiving layer was applied thereto. In Examples 28, 30 and 38, Protecting layer G was further formed on the toner image-receiving layer. Compositions C, E and F for the toner image-receiving layer were applied so that the coating amount after drying would be 15 g/m² with a wire coater and then dried. Composition G for forming the outmost surface (protecting) layer was applied so that the coating amount after drying would be 1 g/m² with a wire coater and then dried.

### <Composition E for Forming Toner Image-Receiving Layer>

| | |
|---|---|
| Polyester resin (Tafton U-5, Kao Corporation) | 100 g |
| Cymac US-380 [silicone resin (releasing agent) | 15 g |
| Toagosei Chemical Industry Co., Ltd.) | |
| Triphenyl phosphate | 9 g |
| Titanium dioxide [Typaque (registered trade name) A-220 | 15 g |
| (Ishihara Sangyo Kaisha Ltd.) | |
| Methyl ethyl ketone | 160 g |

### <Composition F for Forming Toner Image-Receiving Layer>

| | |
|---|---|
| Water-dispersible polyester resin [KZA-7049, | 100 g |
| (Unitika Ltd.)] | |
| Cerezol 524 [carnauba wax (releasing agent) | 30 g |
| (Chukyo Yushi)] | |
| Titanium dioxide [Typaque (registered trade name) A-220 | 0.9 g |
| (Ishihara Sangyo Kaisha Ltd.)] | |
| Methanol | 30 g |
| Water | 10 g |

### <Composition G for Forming Outmost Surface (Protecting) Layer>

| | |
|---|---|
| Peresresin A-515GB [water-dispersible polyester resin | 400 g |
| (Takamatsu Yushi)] | |
| SH7028A [dimethylsiloxane (releasing agent) | 20 g |
| Toray Dow Corning Silicone)] | |
| Water | 400 g |

TABLE 10

Support

| | | Center line average | Corona |
|---|---|---|---|
| | Kind | height (μm) | treatment |
| Example 40 | a-1 | 0.2 | yes |
| Example 41 | a-1 | 0.2 | yes |
| Example 42 | a-1 | 0.2 | yes |
| Example 43 | a-2 | 0.5 | yes |
| Example 44 | a-3 | 0.3 | no |
| Example 45 | a-4 | 0.3 | no |
| Example 46 | a-5 | 0.3 | no |
| Example 47 | a-6 | 0.1 | no |

| | | Outmost surface |
|---|---|---|
| | Toner image-receiving layer | (protecting) layer |
| | (releasing agent) | (releasing agent) |
| Example 40 | E (yes) | no |
| Example 41 | F (yes) | no |
| Example 42 | C (no) | G (yes) |
| Example 43 | F (yes) | no |
| Example 44 | C (no) | G (yes) |
| Example 45 | E (yes) | no |
| Example 46 | F (yes) | no |
| Example 47 | C (no) | G (yes) |

Notes)
Support a-3: OK top coat 157 g/m² (Oji Paper Co., Ltd.) (center line average height on the surface: 0.3 μm)
Support a-4: Mirror coat gold 157 g/m² (Oji Paper Co., Ltd.) (center line average height on the surface: 0.3 μm)
Support a-5: Mirror coat platinum 174 g/m² (Oji Paper Co., Ltd.) (center line average height on the surface: 0.3 μm)
Support a-6: Super mirror coat platinum 174 g/m² (Oji Paper Co., Ltd.) (center line average height on the surface: 0.1 μm)

The characteristic properties of the obtained electrophotographic image-receiving material were evaluated in the same manner as that of Examples 15 to 39. The results are shown in the following Table 11.

TABLE 11

| | Evaluation | | |
|---|---|---|---|
| | Sheet passing | | |
| | property | Gloss | Touch |
| Example 26 | ◯ | ◯ | ◯ |
| Example 27 | ◯ | ◯ | ◯ |
| Example 28 | ◯ | ◯ | ◯ |
| Example 29 | ◯ | ◯ | ◯ |
| Example 30 | ◯ | ◯ | Δ |
| Example 31 | ◯ | ◯ | Δ |
| Example 32 | ◯ | ◯ | Δ |
| Example 33 | ◯ | ◯ | Δ |

According to the present invention, a photographic image-receiving material having an excellent gloss and a touch like that of a photograph, and capable of passing an oil-less machine free of a fixing oil can be obtained.

What is claimed is:

1. An image-receiving material for electrophotography, comprising:
(1) a support, and
(2) a toner image-receiving layer containing a thermoplastic resin,
wherein the center line average height on the surface of said support is 0.01 to 5 μm, and said toner image-receiving layer or another layer contains a releasing agent selected from the group consisting of silicon compounds, fluorine compounds and waxes.

2. The image-receiving material of claim 1, wherein the center line average height on the surface of said support is 0.05 to 3 μm.

3. The image-receiving material of claim 1, wherein said support comprises a base sheet and a polyolefin resin sheet on said base sheet.

4. The image-receiving material of claim 3, wherein said polyolefin resin sheet is polyethylene or polypropylene.

5. The image-receiving material of claim 1, wherein said releasing agent is incorporated into any one of the layers formed on the toner image-receiving layer side of said support.

6. The image-receiving material of claim 5, wherein said releasing agent is incorporated into an outmost surface layer formed on said toner image-receiving layer side of the support.

7. The image-receiving material of claim 1, wherein said releasing agent is selected from the group consisting of silicone oils, silicone resins, silicone rubbers, fluorine oils, fluorine resins, fluorine rubbers, and petroleum waxes.

8. The image-receiving material of claim 1, wherein said releasing agent is selected from the group consisting of silicone oils, silicone resins, carnauba wax, polyethylene wax, and acid amide waxes.
